(19) United States
(12) Patent Application Publication
(10) Pub. No.: US 2009/0059848 A1
(43) Pub. Date: Mar. 5, 2009

(54) Method and System for Supporting Large Number of Data Paths in an Integrated Communication System

(76) Inventors: Amit Khetawat, San Jose, CA (US); Rajeev Gupta, Sunnyvale, CA (US); Patrick Tao, San Jose, CA (US)

Correspondence Address: ADELI & TOLLEN, LLP, 1875 CENTURY PARK EAST, SUITE 1360, LOS ANGELES, CA, 90067, US

(21) Appl. No.: 12/233,571

(22) Filed: Sep. 18, 2008

Related U.S. Application Data
(63) Continuation-in-part of application No. 11/927,627, filed on Oct. 29, 2007.
Application No. 11/927,627 is a continuation-in-part of application No. 11/859,762, filed on Sep. 22, 2007.
Application No. 11/859,762 is a continuation-in-part of application No. 11/927,627, filed on Oct. 29, 2007.
Application No. 11/927,627 is a continuation of application No. 11/778,040, filed on Jul. 14, 2007.
Application No. 11/778,040 is a continuation-in-part of application No. 11/859,762, filed on Sep. 22, 2007.
(60) Provisional application No. 60/973,282, filed on Sep. 18, 2007.
(60) Provisional application No. 61/058,912, filed on Jun. 4, 2008.
(60) Provisional application No. 60/807,470, filed on Jul. 14, 2006.
(60) Provisional application No. 60/823,092, filed on Aug. 21, 2006.
(60) Provisional application No. 60/862,564, filed on Oct. 23, 2006.
(60) Provisional application No. 60/949,826, filed on Jul. 13, 2007.
(60) Provisional application No. 60/826,700, filed on Sep. 22, 2006.
(60) Provisional application No. 60/869,900, filed on Dec. 13, 2006.
(60) Provisional application No. 60/911,862, filed on Apr. 13, 2007.
(60) Provisional application No. 60/949,826, filed on Jul. 13, 2007.
(60) Provisional application No. 60/884,889, filed on Jan. 14, 2007.
(60) Provisional application No. 60/893,361, filed on Mar. 6, 2007.
(60) Provisional application No. 60/884,017, filed on Jan. 8, 2007.
(60) Provisional application No. 60/911,864, filed on Apr. 13, 2007.
(60) Provisional application No. 60/862,564, filed on Oct. 23, 2006.
(60) Provisional application No. 60/949,853, filed on Jul. 14, 2007.
(60) Provisional application No. 60/954,549, filed on Aug. 7, 2007.

(51) Int. Cl. H04W 40/24

(52) U.S. Cl. 370/328

(57) ABSTRACT

Some embodiments provide a method and system for supporting a large set of data paths in a first communication network through a smaller set of data paths over which data services of a core network are accessed. Some embodiments provide such functionality by mapping identifiers associated with the larger set of data paths to a smaller set of proxy identifiers associated with the smaller set of data paths.

### CLAIM OF BENEFIT TO RELATED APPLICATIONS

This application claims the benefit of U.S. Provisional Application 60/973,282, entitled “Methods for Supporting Large Number of GTP-U Paths from SGSN(s),” filed Sep. 18, 2007. The present application also claims the benefit of U.S. Provisional Application 61/058,912 entitled “Transport of RANAP messages over the Iuh Interface,” filed Jun. 4, 2008. The present application is also a Continuation-In-Part of the U.S. Non-Provisional patent application Ser. No. 11/927,627, entitled “Method and Apparatus for Minimizing Number of Active Paths to a Core Communication Network”, filed Oct. 29, 2007, now U.S. Publication No. 2008-0130564 A1. U.S. Non-Provisional patent application Ser. No. 11/927,627 is a Continuation Application of U.S. Non-Provisional patent application Ser. No. 11/778,040 filed Jul. 14, 2007, entitled “Generic Access to the Iu Interface”, now U.S. Publication No. 2008-0039086 A1. U.S. Non-Provisional patent application Ser. No. 11/778,040 claims benefit to U.S. Provisional Patent Application 60/807,470 filed Jul. 14, 2006, entitled “E-UMA Technology”; U.S. Provisional Patent Application 60/823,092 filed Aug. 21, 2006, entitled “Generic Access to the Iu Interface”; U.S. Provisional Patent Application 60/862,564 filed Oct. 23, 2006, entitled “E-UMA—Generic Access to the Iu Interface”; and U.S. Provisional Patent Application 60/949,826 filed Jul. 13, 2007, entitled “Generic Access to the Iu Interface”. The present application is also a Continuation-In-Part of the U.S. Non-Provisional patent application Ser. No. 11/859,762, entitled “Method and Apparatus for Resource Management”, filed Sep. 22, 2007, now U.S. Publication No. 2008-0076425 A1. U.S. Non-Provisional patent application Ser. No. 11/859,762 claims the benefit of U.S. Provisional Application 60/826,700, entitled “Radio Access Network—Generic Access to the Iu Interface for Femtocells”, filed Sep. 22, 2006; U.S. Provisional Application 60/869,900, entitled “Generic Access to the Iu Interface for Femtocells”, filed Dec. 13, 2006; U.S. Provisional Application 60/911,862, entitled “Generic Access to the Iu Interface for Femtocells”, filed Apr. 13, 2007; U.S. Provisional Application 60/949,826, entitled “Generic Access to the Iu Interface”, filed Jul. 13, 2007; U.S. Provisional Application 60/884,889, entitled “Methods to Provide Protection against service Theft for Femtocells”, filed Jan. 14, 2007; U.S. Provisional Application 60/893,361, entitled “Methods to Prevent Theft of Service for Femtocells Operating in Open Access Mode”, filed Mar. 6, 2007; U.S. Provisional Application 60/884,017, entitled “Generic Access to the Iu Interface for Femtocell—Stage 3”, filed Jan. 8, 2007; U.S. Provisional Application 60/911,864, entitled “Generic Access to the Iu Interface for Femtocell—Stage 3”, filed Apr. 13, 2007; U.S. Provisional Application 60/862,564, entitled “E-UMA—Generic Access to the Iu Interface”, filed Oct. 23, 2006; U.S. Provisional Application 60/949,853, entitled “Generic Access to the Iu Interface”, filed Jul. 14, 2007; and U.S. Provisional Application 60/954,549, entitled “Generic Access to the Iu Interfaces—Stage 2 Specification”, filed Aug. 7, 2007. All of the above-mentioned applications, namely 60/973,282, 61/058,912, 11/927,627, 11/778,040, 60/807,470, 60/823,092, 60/862,564, 60/949,826, 11/859,762, 60/826,700, 60/869,900, 60/911,862, 60/949,826, 60/884,889, 60/893,361, 60/884,017, 60/911,864, 60/862,564, 60/949,853, and 60/954,549 are incorporated herein by reference.

### FIELD OF THE INVENTION

The field of invention relates generally to telecommunications. More particularly, this invention relates to methods and systems for integrating a large number of data paths with a packet data services of a core network.

### BACKGROUND OF THE INVENTION

Licensed wireless systems provide mobile wireless communications to individuals using wireless transceivers. Licensed wireless systems refer to public cellular telephone systems and/or Personal Communication Services (PCS) telephone systems. Wireless transceivers include cellular telephones, PCS telephones, smartphones, wireless-enabled personal digital assistants, wireless modems, and the like.

Licensed wireless systems utilize wireless signal frequencies that are licensed from governments. Large fees are paid for access to these frequencies. Expensive base station (BS) equipment is used to support communications on licensed frequencies. Base stations are typically installed approximately a mile apart from one another (e.g., cellular towers in a cellular network). The wireless transport mechanisms and frequencies employed by typical licensed wireless systems limit both data transfer rates and range. As a result, the quality of service (voice quality and speed of data transfer) in licensed wireless systems is considerably inferior to the quality of service afforded by landline (wired) connections. Thus, the user of a licensed wireless system pays relatively high fees for relatively low quality service.

Landline (wired) connections are extensively deployed and generally perform at a lower cost with higher quality voice and higher speed data services. The problem with landline connections is that they constrain the mobility of a user. Traditionally, a physical connection to the landline was required.

In the past few years, the use of unlicensed wireless communication systems (e.g., Unlicensed Mobile Access (UMA) networks and Generic Access Network (GAN)) and other short range wireless communication system that use licensed frequencies (e.g., Home Node B (HNB) Access Network (HNBAN)) to facilitate mobile access to a core network has seen rapid growth. These systems (e.g., UMA, GAN, or HNBAN), individually hereafter referred to as an Integrated Communication System (ICS), provide the convenience associated with licensed wireless communication system networks with the quality of service associated with landline-based networks. For example, such wireless systems may support wireless communication based on the IEEE 802.11a, b or g standards (WiFi), the Bluetooth® standard, or short range licensed wireless frequencies. The mobility range associated with such systems is typically on the order of 100 meters or less. A typical UMA system includes a base station comprising a wireless access point with a physical connection (e.g., coaxial, twisted pair, or optical cable) to a core network. Similarly, a typical GAN system or HNBAN system includes a short range wireless access point, such as a femtocell access point (FAP) or Home Node B (HNB), with a physical connection to a core network.

The access points (APs) of each ICS have a RF transceiver to facilitate communication with a wireless handset that is operative within a modest distance of the AP, wherein the data transport rates supported by the WiFi and Bluetooth® standards are much higher than those supported by the aforementioned licensed wireless systems. Thus, this option provides higher quality services at a lower cost, but the services only extend a modest distance from the base station.

Currently, technology is being developed to integrate the use of licensed and ICS based wireless systems in a seamless fashion that allows the handset to communicate with either system without modifying existing components of a core network. However, in many instances the core network is ill-equipped to support such integration.

One such limitation of the core network exists in data service components of the core network, such as the Serving GPRS (General Packet Radio Service) Support Node (SGSN). The SGSN provides data session mobility management for the wireless devices and Gateway GPRS Support Nodes (GGSNs) of the core network. The SGSN delivers the data packets to a particular GGSN and then the particular GGSN acts as a gateway that establishes an interface for the wireless device to the various external data packet services networks (e.g., public Internet). The data packets for one or more data sessions are passed through GPRS tunnels that carry the user data. These tunnels establish paths between the user equipment telecommunications device or access point and the SGSN or GGSN of the core network using the GPRS Tunnel Protocol (GTP-U path). A GTP-U path is defined as the connection-less unidirectional or bidirectional path between two end-points where each end point is uniquely identified via the combination of the IP address and UDP port. However, each SGSN or GGSN of the core network may be limited in the number of GTP-U paths that it can support. Thus, the core network becomes restricted by virtue of the limited number of GTP-U paths that each SGSN or GGSN can support.

A current ICS is unable to overcome this restriction and therefore must share the limited number of GTP-U paths with the licensed system. As such, ICS and licensed wireless systems become limited in the number of data sessions (or the data session end points) that they can support.

Current packet switched domain architectures of each ICS require that one or more data services for each user equipment telecommunication device within an ICS service region be transmitted over one or more GTP-U tunnels. Accordingly, each tall based stacked AP of a UMA, FAP of a GAN, or HNB of a HNBAN system (hereafter interchangeably referred to as an AP for purposes of simplicity) facilitates such data services for a user equipment within the AP's corresponding service region by operating as one tunnel endpoint with the core network operating as the other tunnel endpoint. FIG. 1 illustrates a typical Femtocell packet switched (PS) domain architecture with such a limitation. As shown, one end of a GTP-U tunnel established to support data services of the user equipment 105 terminates on the AP 110 and the other end of the GTP-U tunnel terminates on the data service providing component of the core network, such as an SGSN 120.

FIG. 2 illustrates the messages exchanged to setup the PS GTP-U tunnel as well as the user data (i.e., uplink and downlink GTP-U packets) exchanged between the AP 210 and SGSN 220. In this figure, the key identifiers used in the transmission of GTP-U packet in the uplink direction (i.e., from AP 210 to SGSN 220) include the IP address of the AP 210 as the source IP address, the AP 210 allocated UDP port as the source UDP port, the IP address of the SGSN 220 as the destination IP address, a destination UDP port, and a SGSN 220 Tunnel Endpoint Identifier (TE-ID). Similarly, the key identifiers used in the transmission of GTP-U packet in the downlink direction (i.e., from SGSN 220 to AP 210) include the IP address of the SGSN 220 as the source IP address, the SGSN 220 allocated UDP port as the source UDP port, the IP address of the AP 210 as the destination IP address, a destination UDP port, and an AP 210 TE-ID. Specifically, a unique IP address of an AP 210 is used to identify one of the tunnel endpoints. Accordingly, each AP through which a user equipment requests data services will be required to establish one or more of its own GTP-U tunnels using its unique IP address in order to access data services of the core network through the SGSN.

As a result, integration of a large number of such APs into the core network detrimentally affects the performance of the various core network SGSNs. The SGSNs are unable to accommodate the increased number of GTP-U paths required by the ICS as the limited number of GTP-U paths supported by each SGSN may be surpassed with a large integration of APs from one or more such ICS. Data services of the core network that are also provided to the licensed wireless networks are thus compromised such that the requests for certain users are denied or are provided in a degraded or limited manner. For example, the SGSN component of the core network may only allow a maximum of two GTP-U paths.

Furthermore, some SGSNs may require that valid paths be preconfigured on the SGSN. For example, the SGSN may include a static list of potential peer IP addresses. In such cases, the ICS would be unable to grow as new users deploy additional APs. There is also a concern of exposing the SGSN IP address to each such AP as the AP is a Customer Premise Equipment (CPE) that may pose potential security threats to the SGSN and other core network elements as a result of exposing the SGSN IP address.

Possible solutions are to update the SGSN or GGSN to handle larger number of paths, to disable path management, or to separate path management IP addressing from the actual packet switched (PS) user data IP address. However, each such solution requires changes to components of the core network and to the functionality of the core network. As such, these solutions, while feasible, require extensive change and cost and the effects impact the core network, ICS, and also the licensed wireless systems.

For example, updating the SGSN to handle a large number of paths requires changes to legacy limitations that are currently deployed throughout the core network. Some such limitations may be due to assumptions about the number of Radio Network Controllers (RNCs) or GPRS Support Nodes (GSNs) adjacencies in the core network. Therefore, to scale to a large number of AP deployments for an ICS, each with High Speed Downlink Packet Access (HSDPA) data rates, it would be essential that such legacy limitations be removed and any unnecessary forwarding elements be avoided in the user plane path.

Disabling path management could result in a broken user plane path remaining undetected until it affects the IPSec tunnel which would then be detected by a keep alive mechanism. Such an approach may introduce additional latency and delay. Similarly, separating path management IP addressing from the actual PS user data IP addressing requires that a separate (pseudo) destination IP address be configured on each SGSN. This separate IP address is used for path management only (i.e., a pseudo entity that responds to Echo Requests sent by the SGSN). The IP address used for PS data transport will be communicated over the Iu interface. The overhead for such an approach requires changes to the existing components of the core network (e.g., SGSN). Additionally, this approach assumes that the SGSN does not verify that an active PDP context exists on the path being monitored and that the SGSN does not verify that the IP address received in the (RAB) Assignment Response belongs to the set of IP addresses being path monitored.

Accordingly, there is a need to address the limitations associated with integrating an ICS into a core network. In so doing, there is a need to integrate the APs into the core network such that the integration is seamless to the components of the core network and the impact is minimal. In other words, there is a need to address the limitations without requiring modifications to the components of the core network and without detrimentally affecting the data service performance for existing licensed wireless systems or for other systems or networks that utilize the data services provided by the core network.

### SUMMARY OF THE INVENTION

Some embodiments are implemented in a communication system that includes a first wireless communication network, a second licensed wireless communication network, and a core network. In some embodiments, the first communication network includes several access points (APs), each servicing a service region of the first communication network, and a network controller that can communicatively couple one or more service regions to the core network.

Some such embodiments provide a method and system for supporting a large set of data paths in the first communication network through a smaller set of data paths over which data services of the core network are accessed. Some embodiments provide such functionality by mapping identifiers associated with the larger set of data paths to a smaller set of proxy identifiers associated with the smaller set of data paths.

In some embodiments, each data path is uniquely identified based on an IP address and UDP port combination. In some embodiments, the data paths include one or more GTP-U tunnels. Each GTP-U tunnel is uniquely identified based on a combination of an IP address and a Tunnel Endpoint Identifier (TE-ID). GTP-U tunnels in the larger set of paths may share an IP address or TE-ID, but not both. Therefore, some embodiments perform a mapping whereby redundancies in the larger set of paths may be used to index a smaller set of proxy identifiers that reduce the number of paths terminated between the first communication network and the core network. In some embodiments, the proxy identifiers include a proxy IP address, a proxy TE-ID, or both.

In some embodiments, the network controller performs the mapping between the larger and smaller set of paths for uplink and downlink packets. To perform the mapping, the network controller identifies the identifiers associated with each terminated GTP-U tunnel (e.g., using the source IP address and TE-ID assigned to the tunnel) in a GTP-U path and the identifiers associated with the GTP-U path itself (e.g., using the source IP address and source UDP port). In some embodiments, the endpoint for the GTP-U path is an AP that services the service region. In other embodiments, the endpoint for the GTP-U path is a user equipment operating within the service region.

In some embodiments, the network controller performs uplink mapping based on the identifiers. Specifically, the network controller utilizes the identified TE-ID of an uplink packet to index a proxy IP address. Additionally, the network controller maps the source IP address of the uplink packet to a TE-ID. The uplink packet with the mapped identifiers is then associated with one data path in the smaller set of data paths that is terminated between the network controller and a data services component of the core network, such as a Serving GPRS (General Packet Radio Service) Support Node (SGSN) or a GPRS Support Node (GGSN). The uplink packet is then transmitted through the associated data path in the smaller set of data paths.

In this manner, the maximum number of data paths established between the network controller and the core network will never exceed the maximum number of GTP-U tunnels supported by any single FAP of the first communication network. In some embodiments, all GTP-U tunnels for data paths terminated between one or more APs serviced by a network controller and the network controller are mapped to a single data path by automatically configuring the proxy identifiers.

The network controller similarly performs mapping of downlink packets from the smaller set of paths between the network controller and the core network back to the larger set of paths between the network controller and one or more APs. In some embodiments, the network controller remaps the proxy identifiers (e.g., proxy IP address, proxy TE-ID, or both) of the smaller set of paths to the actual IP address and actual TE-ID of the larger set of paths terminated between the APs and the network controller.

In some embodiments, the network controller facilitates the identifier mapping by using a proxy identifier management component that is either a component of the network controller or a component external to the network controller but that operates in conjunction with the network controller. Together, these components provide the path management and mapping functionality with no change to the existing components of the core network and without limiting the functionality of the data services provided within the first communication network.

In some embodiments, this path mapping functionality is applicable to any UMA, GAN, Femtocell, or HNBAN system, to any tall-stack based access point (AP) of such systems, and to any network controller of such systems. Additionally, the methods and systems of some embodiments are also similarly applicable to any computer equipment terminating/originating the GTP-U tunnels.

### BRIEF DESCRIPTION OF THE DRAWINGS

The novel features of the invention are set forth in the appended claims. However, for purpose of explanation, several embodiments of the invention are set forth in the following figures.

FIG. 1 illustrates a typical Femtocell architecture that requires one end of the GTP-U tunnel to terminate on the FAP and the other end of the GTP-U tunnel to terminate on the data service providing component of the core network, such as an SGSN.

FIG. 2 illustrates the messages exchanged to setup the PS GTP-U tunnel as well as the user data (i.e., uplink and downlink GTP-U packets) exchanged between the FAP and SGSN.

FIG. 3 illustrates an integrated communication system (ICS) of some embodiments.

FIG. 4 illustrates several applications of an ICS in some embodiments.

FIG. 5 illustrates the overall A/Gb-mode GAN functional architecture of some embodiments.

FIG. 6 illustrates the overall Iu-mode GAN functional architecture of some embodiments.

FIG. 7 illustrates the Femtocell functional architecture of some embodiments.

FIG. 8 illustrates the Home Node B Access Network (HNBAN) functional architecture of some embodiments.

FIG. 9 illustrates the basic elements of a Femtocell system architecture with Asynchronous Transfer Mode (ATM) transport based Iu interfaces towards the core network in some embodiments.

FIG. 10 illustrates the basic elements of a Femtocell system architecture with an IP based transport Iu interface towards the core network in some embodiments.

FIG. 11 illustrates PS domain control plane architecture of some embodiments.

FIG. 12 illustrates PS domain control plane architecture of some embodiments.

FIG. 13 illustrates the HNBAN architecture of some embodiments in support of the PS/CS Domain Control Plane.

FIG. 14 illustrates PS domain user plane protocol architecture of some embodiments.

FIG. 15 illustrates PS domain user plane protocol architecture of some embodiments.

FIG. 16 illustrates multiple data paths established between different APs and a SGSN of a core network in accordance with some embodiments.

FIG. 17 illustrates integrating APs of an ICS of some embodiments with a SGSN of a core network that services RNCs and BSCs of other licensed wireless networks.

FIG. 18 provides a first manner of integrating path termination and path mapping functionality of some embodiments into a GANC.

FIG. 19 provides a second manner of integrating path termination and path mapping functionality of some embodiments into a GANC.

FIG. 20 provides a third manner of integrating path termination and path mapping functionality of some embodiments into a GANC.

FIG. 21 illustrates a mapping table for proxy addresses utilized by the GANC of some embodiments to reduce the number of GTP-U paths needed between the GANC and core network in for data passing between the various GTP-U paths between the GANC and APs.

FIG. 22 illustrates a network controller of some embodiments performing the mapping between the larger set of data paths established with the APs and the smaller set of data paths established with the core network.

FIG. 23 illustrates an implementation of the mapping functionality performed by some embodiments for downlink data transmission.

FIG. 24 presents a message and data flow diagram that illustrates some of the messages and operations employed to facilitate path termination and path mapping functionality in accordance with some embodiments of the invention.

FIG. 25 presents a message and data flow diagram that illustrates the setting up of multiple GTP-U tunnels from the same AP in accordance with some embodiments.

FIG. 26 conceptually illustrates the automatic configuration functionality that facilitates the dynamic allocation and mapping of the larger set of set of GTP-U paths established between APs and a GANC and a single path established between the GANC and a SGSN.

FIG. 27 presents a message and data flow diagram that illustrates some of the messages and operations employed to facilitate automatic configuration of virtual addressing and identifiers for path mapping in accordance with some embodiments of the invention.

FIG. 28 presents a process implemented in conjunction with the path mapping described above to provide IP address masking functionality for components of the core network (e.g., SGSN).

FIG. 29 illustrates a computer system with which some embodiments of the invention are implemented.

### DETAILED DESCRIPTION OF THE INVENTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Throughout the following description, acronyms commonly used in the telecommunications industry for wireless services are utilized along with acronyms specific to the present invention. A table of acronyms used in this application is included in Section VI.

Some embodiments are implemented in a communication system that includes a first wireless communication network, a second licensed wireless communication network, and a core network. In some embodiments, the first communication network includes several access points (APs), each servicing a service region of the first communication network, and a network controller that can communicatively couple one or more service regions to the core network.

Some such embodiments provide a method and system for supporting a large set of data paths in the first communication network through a smaller set of data paths over which data services of the core network are accessed. Some embodiments provide such functionality by mapping identifiers associated with the larger set of data paths to a smaller set of proxy identifiers associated with the smaller set of data paths.

In some embodiments, each data path is uniquely identified based on an IP address and UDP port combination. In some embodiments, the data paths include one or more GTP-U tunnels. Each GTP-U tunnel is uniquely identified based on a combination of an IP address and a Tunnel Endpoint Identifier (TE-ID). GTP-U tunnels in the larger set of paths may share an IP address or TE-ID, but not both. Therefore, some embodiments perform a mapping whereby redundancies in the larger set of paths may be used to index a smaller set of proxy identifiers that reduce the number of paths terminated between the first communication network and the core network. In some embodiments, the proxy identifiers include a proxy IP address, a proxy TE-ID, or both.

In some embodiments, the network controller performs the mapping between the larger and smaller set of paths for uplink and downlink packets. To perform the mapping, the network controller identifies the identifiers associated with each terminated GTP-U tunnel (e.g., using the source IP address and TE-ID assigned to the tunnel) in a GTP-U path and the identifiers associated with the GTP-U path itself (e.g., using the source IP address and source UDP port). In some embodiments, the endpoint for the GTP-U path is an AP that services the service region. In other embodiments, the endpoint for the GTP-U path is a user equipment operating within the service region.

In some embodiments, the network controller performs uplink mapping based on the identifiers. Specifically, the network controller utilizes the identified TE-ID of an uplink packet to index a proxy IP address. Additionally, the network controller maps the source IP address of the uplink packet to a TE-ID. The uplink packet with the mapped identifiers is then associated with one data path in the smaller set of data paths that is terminated between the network controller and a data services component of the core network, such as a Serving GPRS (General Packet Radio Service) Support Node (SGSN) or a GPRS Support Node (GGSN). The uplink packet is then transmitted through the associated data path in the smaller set of data paths.

In this manner, the maximum number of data paths established between the network controller and the core network will never exceed the maximum number of GTP-U tunnels supported by any single FAP of the first communication network. In some embodiments, all GTP-U tunnels for data paths terminated between one or more APs serviced by a network controller and the network controller are mapped to a single data path by automatically configuring the proxy identifiers.

The network controller similarly performs mapping of downlink packets from the smaller set of paths between the network controller and the core network back to the larger set of paths between the network controller and one or more APs. In some embodiments, the network controller remaps the proxy identifiers (e.g., proxy IP address, proxy TE-ID, or both) of the smaller set of paths to the actual IP address and actual TE-ID of the larger set of paths terminated between the APs and the network controller.

In some embodiments, the network controller facilitates the identifier mapping by using a proxy identifier management component that is either a component of the network controller or a component external to the network controller but that operates in conjunction with the network controller. Together, these components provide the path management and mapping functionality with no change to the existing components of the core network and without limiting the functionality of the data services provided within the first communication network.

In some embodiments, this path mapping functionality is applicable to any UMA, GAN, Femtocell, or HNBAN system, to any tall-stack based access point (AP) of such systems, and to any network controller of such systems. Additionally, the methods and systems of some embodiments are also similarly applicable to any computer equipment terminating/originating the GTP-U tunnels.

Several more detailed embodiments of the invention are described in sections below. Specifically, Section I describes a communication system that includes at least a first integrated communication system of some embodiments, a second licensed wireless communication system, and a core network. The discussion in Section I is followed by a discussion of a Femtocell system architecture of some embodiments in Section II. Next, Section III describes packet switched control and user plane architectures in accordance with some embodiments of the invention. Section IV then describes methods and procedures performed by some embodiments of the invention to support a large number of GTP-U paths within the packet switched user plane architecture. The discussion is followed by Section V description of a computer system with which some embodiments of the invention are implemented. Finally, Section VI lists the abbreviations used.

### I. OVERALL SYSTEM

A. Integrated Communication Systems (ICS)

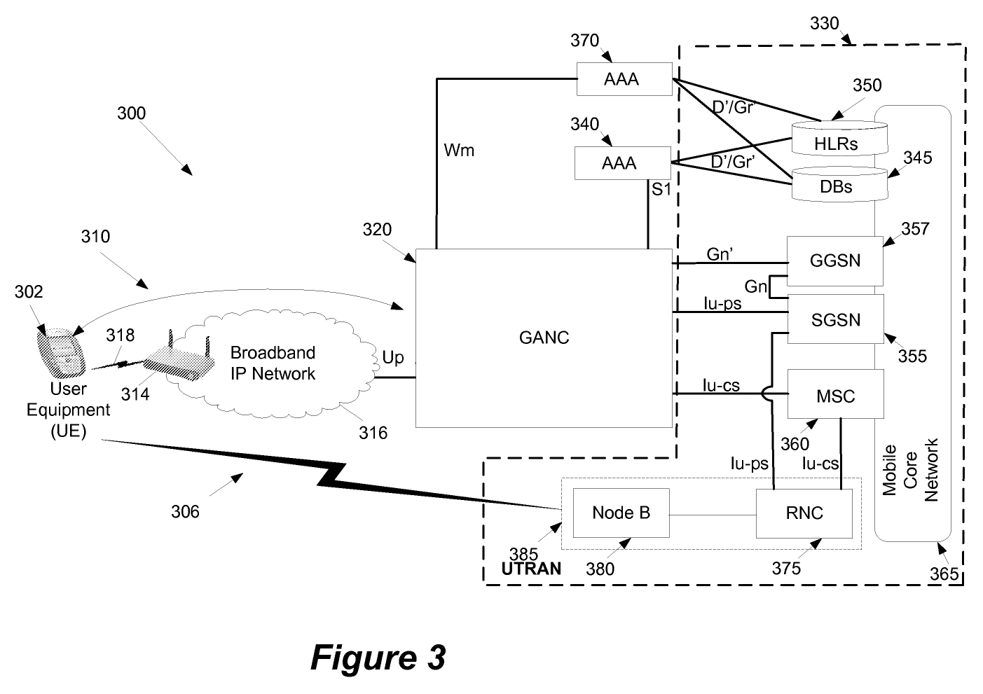

FIG. 3 illustrates an integrated communication system (ICS) architecture 300 in accordance with some embodiments of the present invention. ICS architecture 300 enables user equipment (UE) 302 to access a voice and data network 365 via either a licensed air interface 306 or an ICS access interface 310 through which components of the licensed wireless core network 365 are alternatively accessed. In some embodiments, the ICS access interface 310 includes an unlicensed wireless interface of a UMA or GAN or a short-range licensed wireless interface of a GAN, Femtocell system, or HNBAN. In some embodiments, a communication session through either interface includes voice services, data services, or both.

The mobile core network 365 includes one or more Home Location Registers (HLRs) 350 and databases 345 for subscriber authentication and authorization. Once authorized, the UE 302 may access the voice and data services of the mobile core network 365. In order to provide such services, the mobile core network 365 includes a mobile switching center (MSC) 360 for providing access to the circuit switched services (e.g., voice and data). Packet switched services are provided for through a Serving GPRS (General Packet Radio Service) Support Node (SGSN) 355 in conjunction with a gateway such as the Gateway GPRS Support Node (GGSN) 357.

The SGSN 355 is typically responsible for delivering data packets from and to the GGSN 357 and the user equipment within the geographical service area of the SGSN 355. Additionally, the SGSN 355 may perform functionality such as mobility management, storing user profiles, and storing location information. However, the actual interface from the mobile core network 365 to various external data packet services networks (e.g., public Internet) is facilitated by the GGSN 357. As the data packets originating from the user equipment typically are not structured in the format with which to access the external data networks, it is the role of the GGSN 357 to act as the gateway into such packet services networks. In this manner, the GGSN 357 provides addressing for data packets passing to and from the UE 302 and the external packet services networks (not shown). Moreover, as the user equipment of a licensed wireless network traverses multiple service regions and thus multiple SGSNs, it is the role of the GGSN 357 to provide a static gateway into the external data networks.

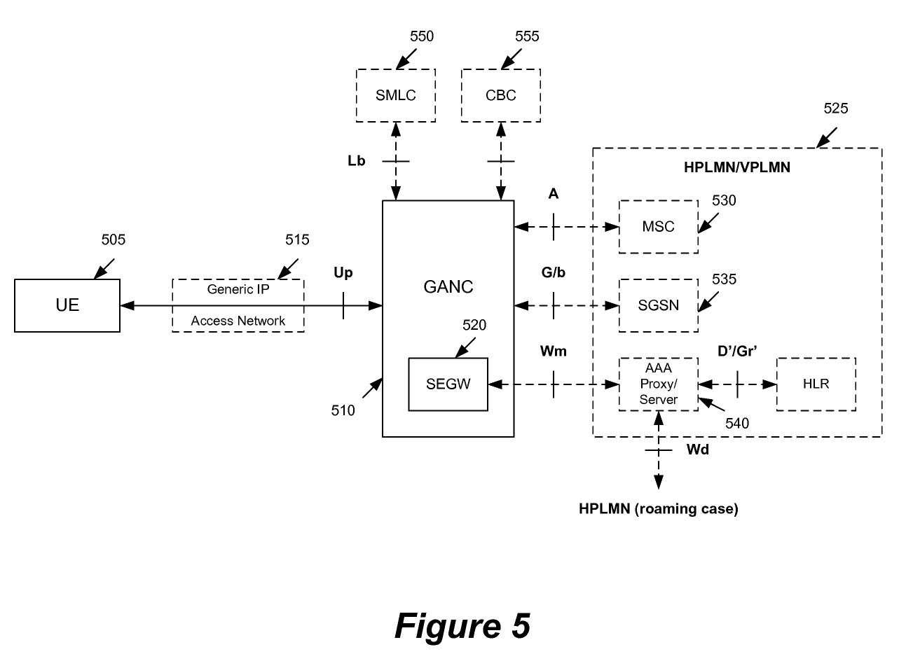

In the illustrated embodiment, components common to a UMTS Terrestrial Radio Access Network (UTRAN), based cellular network that includes multiple base stations referred to as Node Bs 380 (of which only one is shown for simplicity) that facilitate wireless communication services for various user equipment 302 via respective licensed radio links 306 (e.g., radio links employing radio frequencies within a licensed bandwidth). However, one of ordinary skill in the art will recognize that in some embodiments, the licensed wireless network may include other components such the GSM/EDGE Radio Access Network (GERAN). An example of a system using A and Gb interfaces to access GERAN is shown in FIG. 5 described further below.

The licensed wireless channel 306 may comprise any licensed wireless service having a defined UTRAN or GERAN interface protocol (e.g., Iu-cs and Iu-ps interfaces for UTRAN or A and Gb interfaces for GERAN) for a voice/data network. The UTRAN 385 typically includes at least one Node B 380 and a Radio Network Controller (RNC) 375 for managing the set of Node Bs 380. Typically, the multiple Node Bs 380 are configured in a cellular configuration (one per each cell) that covers a wide service area. A licensed wireless cell is sometimes referred to as a macro cell which is a logical term used to reference, e.g., the UMTS radio cell (i.e., 3G cell) under Node-B/RNC which is used to provide coverage typically in the range of tens of kilometers. Also, the UTRAN or GERAN is sometimes referred to as a macro network.

Each RNC 375 communicates with components of the core network 365 through a standard radio network controller interface such as the Iu-cs and Iu-ps interfaces depicted in FIG. 3. For example, a RNC 375 communicates with MSC 360 via the UTRAN Iu-cs interface for circuit switched services. Additionally, the RNC 375 communicates with SGSN 355 via the UTRAN Iu-ps interface for packet switched services through GGSN 357. Moreover, one of ordinary skill in the art will recognize that in some embodiments, other networks with other standard interfaces may apply. For example, the RNC 375 in a GERAN network is replaced with a Base Station Controller (BSC) that communicates with the MSC 360 via an A interface for the circuit switched services and the BSC communicates with the SGSN via a Gb interface of the GERAN network for packet switched services.

In some embodiments of the ICS architecture, the user equipment 302 use the services of the mobile core network (CN) 365 via a second communication network facilitated by the ICS access interface 310 and a network controller 320. In some embodiments, the network controller 320 includes a Generic Access Network Controller (GANC) of a GAN, a Home Node B (HNB) Gateway (HNB-G) of a HNB Access Network (HNBAN), or an Unlicensed Mobile Access (UMA) network controller of a UMA network (also referred to as a Universal Network Controller). In the following discussion, the network controller 320 will be referred to as a GANC. However, it should be apparent to one of ordinary skill in the art that the network controller may alternatively include a HNB Gateway (HNB-G) or an UMA network controller.

In some embodiments, the voice and data services over the ICS access interface 310 are facilitated via an access point 314 communicatively coupled to a broadband IP network 316. In some embodiments, the access point 314 is a generic wireless access point that connects the user equipment 302 to the ICS through an unlicensed wireless network 318 created by the access point (AP) 314. In some other embodiments, the access point 314 is a Femtocell access point (FAP) 314 communicatively coupled to a broadband IP network 316. The FAP facilitates short-range licensed wireless communication sessions 318 that operate independent of the licensed communication session 306. In some embodiments, the GANC, FAP, UE, and the area covered by the FAP are collectively referred to as a Femtocell System. A Femtocell spans a smaller area (typically few tens of meters) than a macro cell. In other words, the Femtocell is a micro cell that has a range that is 100, 1000, or more times less than a macro cell. In case of the Femtocell system, the user equipment 302 connects to the ICS through a short-range licensed wireless network created by the FAP 314. Signals from the FAP are then transmitted over the broadband IP network 316. In some embodiments, the FAP is a Home Node B (HNB) as described in further detail below.

The signaling from the UE 302 is passed over the ICS access interface 310 to the GANC 320. After the GANC 320 performs authentication and authorization of the subscriber, the GANC 320 communicates with components of the mobile core network 365 using a radio network controller interface that is the same or similar to the radio network controller interface of the UTRAN described above, and includes a UTRAN Iu-cs interface for circuit switched services and a UTRAN Iu-ps interface for packet switched services (e.g., GPRS). In this manner, the GANC 320 uses the same or similar interfaces to the mobile core network as a UTRAN Radio Access Network Subsystem (e.g., the Node B 380 and RNC 375).

In some embodiments, the GANC 320 communicates with other system components of the ICS through one or more of several other interfaces, which are (1) “Up”, (2) “Wm”, (3) “D′/Gr′”, (4) “Gn′”, and (5) “S1”. The “Up” interface is the standard interface for session management between the UE 302 and the GANC 320. The “Wm” interface is a standardized interface between the GANC 320 and an Authorization, Authentication, and Accounting (AAA) Server 370 for authentication and authorization of the UE 302 into the ICS. The “D′/Gr′” interface is the standard interface between the AAA server 370 and the HLR 360. Optionally, some embodiments use the “Gn′” interface which is a modified interface for direct communications with the data services gateway (e.g., GGSN) of the mobile core network. Some embodiments optionally include the “S1” interface. In these embodiments, the “S1” interface provides an authorization and authentication interface from the GANC 320 to an AAA server 340. In some embodiments, the AAA server 340 that supports the S1 interface and the AAA server 370 that supports Wm interface may be the same. More details of the S1 interface are described in U.S. Patent Publication 2006-0223498, entitled “Service Access Control Interface for an Unlicensed Wireless Communication System”, filed Feb. 6, 2006.

However, it should be apparent to one of ordinary skill in the art, that when the UE 302 accesses the ICS through a different network controller (e.g., UMA network controller or HNB Gateway) or AP (e.g., HNB) then some or all such interfaces maybe different. For instance, in some embodiments the interface between the AP and the UE 302 is a “Uu” interface and the interface between the AP and the HNB Gateway is the Iu-h interface.

In some embodiments, the UE 302 must register with the GANC 320 prior to accessing ICS services. Registration information of some embodiments includes a subscriber's International Mobile Subscriber Identity (IMSI), a Media Access Control (MAC) address, and a Service Set Identifier (SSID) of the serving access point as well as the cell identity from the GSM or UTRAN cell upon which the UE 302 is already camped (a UE is camped on a cell when the UE has completed the cell selection/reselection process and has chosen a cell; the UE monitors system information and, in most cases, paging information). In some embodiments, the GANC 320 may pass this information to the AAA server 340 to authenticate the subscriber and determine the services (e.g., voice and data) available to the subscriber. If approved by the AAA server 340 for access, the GANC 320 will permit the UE 302 to access voice and data services of the ICS.

These circuit switched and packet switched services are seamlessly provided by the ICS to the UE 302 through the various interfaces described above. In some embodiments, when data services are requested by the UE 302, the ICS uses the optional Gn′ interface for directly communicating with a GGSN 357. The Gn′ interface allows the GANC 320 to avoid the overhead and latency associated with communicating with the SGSN 355 over the Iu-ps interface of the UTRAN or the Gb interface of the GSM core networks prior to reaching the GGSN 357.

B. Applications of ICS

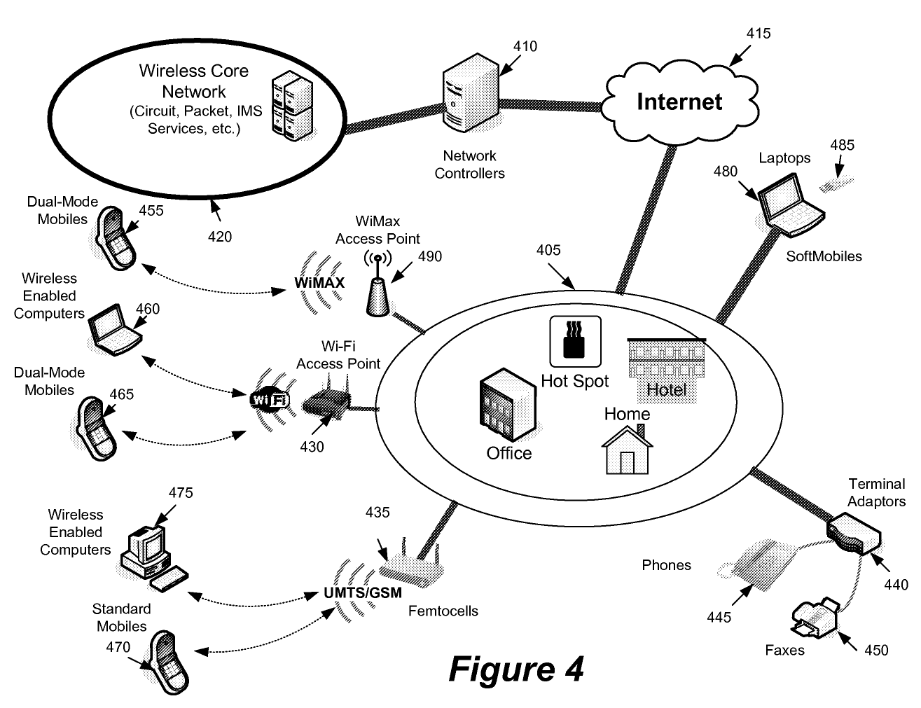

An ICS provides scalable and secure interfaces into the core service network of mobile communication systems. FIG. 4 illustrates several applications of an ICS in some embodiments. As shown, homes, offices, hot spots, hotels, and other public and private places 405 are connected to one or more network controllers 410 (such as the GANC 320 shown in FIG. 3) through the Internet 415. The network controllers in turn connect to the mobile core network 420 (such as the core network 365 shown in FIG. 3).

FIG. 4 also shows several user equipments. These user equipments are just examples of user equipments that can be used for each application. Although in most examples only one of each type of user equipments is shown, one of ordinary skill in the art would realize that other type of user equipments can be used in these examples without deviating from the teachings of the invention. Also, although only one of each type of access points, user equipment, or network controllers are shown, many such access points, user equipments, or network controllers may be employed in FIG. 4. For instance, an access point may be connected to several user equipment, a network controller may be connected to several access points, and several network controllers may be connected to the core network. The following sub-sections provide several examples of services that can be provided by an ICS.

1. Wi-Fi

A Wi-Fi access point 430 enables a dual-mode cellular/Wi-Fi UEs 460-465 to receive high-performance, low-cost mobile services when in range of a home, office, or public Wi-Fi network. With dual-mode UEs, subscribers can roam and handover between licensed wireless communication system and Wi-Fi access and receive a consistent set of services as they transition between networks.

2. Femtocells

A Femtocell enables user equipments, such as standard mobile stations 470 and wireless enabled computers 475 shown, to receive low cost services using a short-range licensed wireless communication sessions through a FAP 435. In some embodiments, each FAP establishes a service region of a GAN, where a network controller of the GAN services one or more such service regions. Accordingly, each FAP includes a receiver for receiving messages and a transceiver for transmitting message to and from a UE or network controller. It should be apparent to one of ordinary skill in the art that a Home Node B offers similar functionality to that of the FAP 435. Specifically, a Home Node B (HNB) offers a standard radio interface for user equipment connectivity where the radio interface operates independent of the licensed communication session. The HNB creates a short-ranged wireless service region for facilitating wireless communication sessions with one or more UEs. Signals from the HNB are then transmitted over the broadband IP network. The HNB supports RNC like functions and operates over an Iu-h interface that supports relaying of RANAP messaging between the core network and a HNBAN. In some embodiments, each FAP/HNB establishes a service region of a GAN, where a network controller of the GAN services one or more such service regions. Accordingly, each HNB includes a receiver for receiving messages and a transceiver for transmitting message to and from a UE or network controller.

3. Terminal Adaptors

Terminal adaptors 440 allow incorporating fixed-terminal devices such as telephones 445, Faxes 450, and other equipments that are not wireless enabled within the ICS. As far as the subscriber is concerned, the service behaves as a standard analog fixed telephone line. The service is delivered in a manner similar to other fixed line VoIP services, where a UE is connected to the subscriber's existing broadband (e.g., Internet) service.

4. WiMAX

Some licensed wireless communication system operators are investigating deployment of WiMAX networks in parallel with their existing cellular networks. A dual mode cellular/WiMAX UE 455 enables a subscriber to seamlessly transition between a cellular network and such a WiMAX network through a WiMax access point 490.

5. SoftMobiles

Connecting laptops 480 to broadband access at hotels and Wi-Fi hot spots has become popular, particularly for international business travelers. In addition, many travelers are beginning to utilize their laptops and broadband connections for the purpose of voice communications. Rather than using mobile phones to make calls and pay significant roaming fees, they utilize SoftMobiles (or SoftPhones) and VoIP services when making long distance calls.

To use a SoftMobile service, a subscriber would place a USB memory stick 485 with an embedded SIM into a USB port of their laptop 480. A SoftMobile client would automatically launch and connect over IP to the mobile service provider. From that point on, the subscriber would be able to make and receive mobile calls as if she was in her home calling area.

Several examples of Integrated Communication Systems (ICS) are given in the following sub-sections. A person of ordinary skill in the art would realize that the teachings in these examples can be readily combined. For instance, an ICS can be an IP based system and have an A/Gb interface towards the core network while another ICS can have a similar IP based system with an Tu interface towards the core network.

C. Integrated Systems with A/Gb and/or Iu Interfaces Towards the Core Network

FIG. 5 illustrates the A/Gb-mode Generic Access Network (GAN) functional architecture of some embodiments. The GAN includes one or more Generic Access Network Controllers (GANC) 510 and one or more generic IP access networks 515. One or more UEs 505 (one is shown for simplicity) can connect to a GANC 510 through a generic IP access network 515. The GANC 510 has the capability to appear to the core network 525 as a GSM/EDGE Radio Access Network (GERAN) Base Station Controller (BSC). The GANC 510 includes a Security Gateway (SeGW) 520 that terminates secure remote access tunnels from the UE 505, providing mutual authentication, encryption and data integrity for signaling, voice and data traffic.

The generic IP access network 515 provides connectivity between the UE 505 and the GANC 510. The IP transport connection extends from the GANC 510 to the UE 505. A single interface, the Up interface, is defined between the GANC 510 and the UE 505.

The GAN co-exists with the GERAN and maintains the interconnections with the Core Network (CN) 525 via the standardized interfaces defined for GERAN. These standardized interfaces include the A interface to Mobile Switching Center (MSC) 530 for circuit switched services, Gb interface to Serving GPRS Support Node (SGSN) 535 for packet switched services, Lb interface to Serving Mobile Location Center (SMLC) 550 for supporting location services, and an interface to Cell Broadcast Center (CBC) 555 for supporting cell broadcast services. The transaction control (e.g., Connection Management (CM) and Session Management (SM)) and user services are provided by the core network (e.g., MSC/VLR and the SGSN/GGSN).

As shown, the SeGW 520 is connected to a AAA server 540 over the Wm interface. The AAA server 540 is used to authenticate the UE 505 when it sets up a secure tunnel. Some embodiments require only a subset of the Wm functionalities for the GAN application. In these embodiments, as a minimum the GANC-SeGW shall support the Wm authentication procedures.

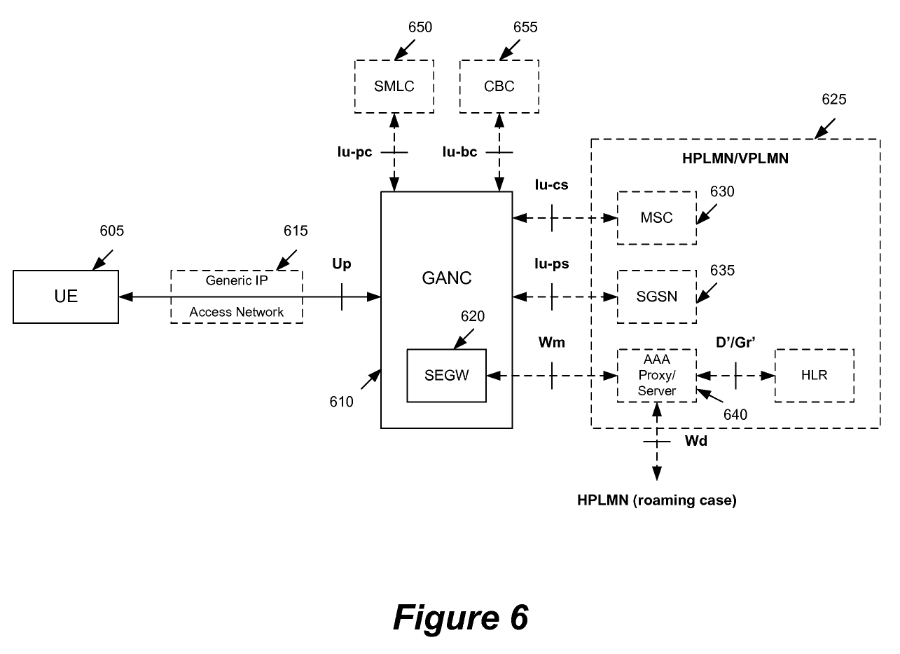

FIG. 6 illustrates the Iu-mode GAN functional architecture of some embodiments. The GAN includes one or more GANCs 610 and one or more generic IP access networks 615. One or more UEs 605 (one is shown for simplicity) can be connected to a GANC 610 through a generic IP access network 615. In comparison with the GANC 510, the GANC 610 has the capability to appear to the core network 625 as a UMTS Terrestrial Radio Access Network (UTRAN) Radio Network Controller (RNC). In some embodiments, the GANC has the expanded capability of supporting both the Tu and A/Gb interfaces to concurrently support both Iu-mode and A/Gb-mode UEs. Similar to the GANC 510, the GANC 610 includes a Security Gateway (SeGW) 620 that terminates secure remote access tunnels from the UE 605, providing mutual authentication, encryption and data integrity for signaling, voice and data traffic.

The generic IP access network 615 provides connectivity between the UE 605 and the GANC 610. The IP transport connection extends from the GANC 610 to the UE 605. A single interface, the Up interface, is defined between the GANC 610 and the UE 605. Functionality is added to this interface, over the UP interface shown in FIG. 5, to support the Iu-mode GAN service.

The GAN co-exists with the UTRAN and maintains the interconnections with the Core Network (CN) 625 via the standardized interfaces defined for UTRAN. These standardized interfaces include the Iu-cs interface to Mobile Switching Center (MSC) 630 for circuit switched services, Iu-ps interface to SGSN 635 for packet switched services, Iu-pc interface to Serving Mobile Location Center (SMLC) 650 for supporting location services, and Iu-bc interface to Cell Broadcast Center (CBC) 655 for supporting cell broadcast services. The transaction control (e.g. Connection Management (CM) and Session Management (SM)) and user services are provided by the core network (e.g. MSC/VLR and the SGSN/GGSN).

As shown, the SeGW 620 is connected to a AAA server 640 over the Wm interface. The AAA server 640 is used to authenticate the UE 605 when it sets up a secure tunnel. Some embodiments require only a subset of the Wm functionalities for the Iu mode GAN application. In these embodiments, as a minimum the GANC-SeGW shall support the Wm authentication procedures.

### II. FEMTOCELL SYSTEM ARCHITECTURE

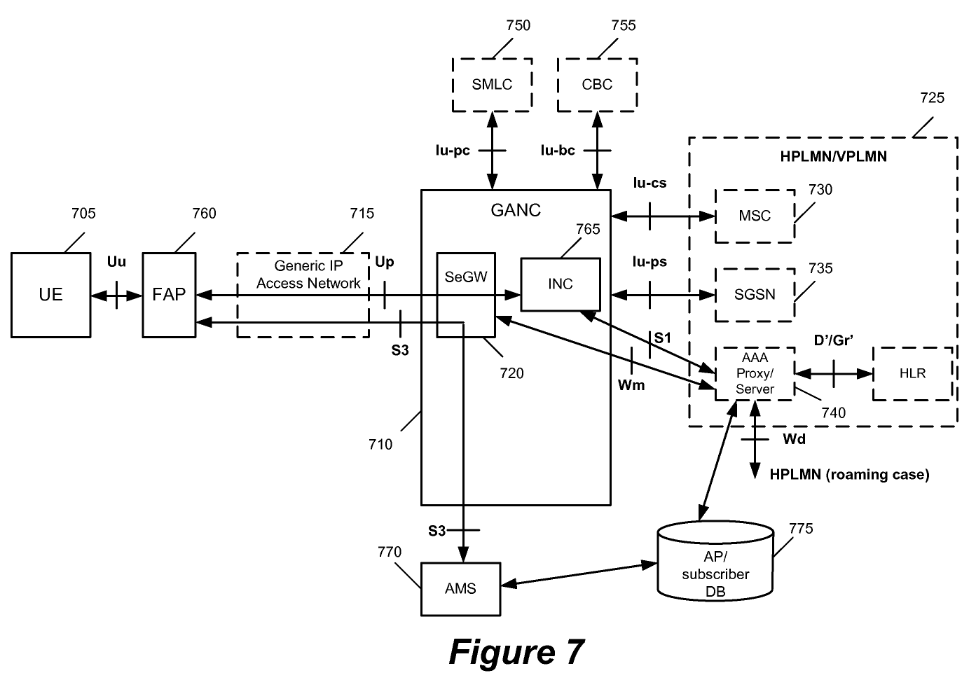

FIG. 7 illustrates the Femtocell system functional architecture of some embodiments. As shown, many components of the system shown in FIG. 7 are similar to components of FIG. 6. In addition, the Femtocell system includes a Femtocell Access Point (FAP) 760 which communicatively couples the UE 705 to the GANC 710 through the Generic IP Access Network 715. The interface between the UE 705 and the FAP 760 is referred to as the Uu interface in this disclosure. The UE 705 and the FAP 760 communicate through a short-range wireless air interface using licensed wireless frequencies. The GANC 710 is an enhanced version of the GANC 610 shown in FIG. 6. The Security Gateway (SeGW) 720 component of the GANC 710 terminates secure remote access tunnels from the FAP 760, providing mutual authentication, encryption and data integrity for signaling, voice and data traffic.

The Femtocell Access Point (AP) Management System (AMS) 770 is used to manage a large number of FAPs. The AMS 770 functions include configuration, failure management, diagnostics, monitoring and software upgrades. The interface between the AMS 770 and the FAP 760 is referred to as the S3 interface. The S3 interface enables secure access to Femtocell access point management services for FAPs. All communication between the FAPs and AMS is exchanged via the Femtocell secure tunnel that is established between the FAP and SeGW 720. As shown, the AMS 770 accesses to the AP/subscriber databases (Femtocell DB) 775 which provides centralized data storage facility for Femtocell AP (i.e., the FAP) and subscriber information. Multiple Femtocell system elements may access Femtocell DB via AAA server.

The IP Network Controller (INC) 765 component of the GANC 710 interfaces with the AAA/proxy server 740 through the S1 interface for provisioning of the FAP related information and service access control. As shown in FIG. 7, the AAA/proxy server 740 also interfaces with the AP/subscriber databases 775.

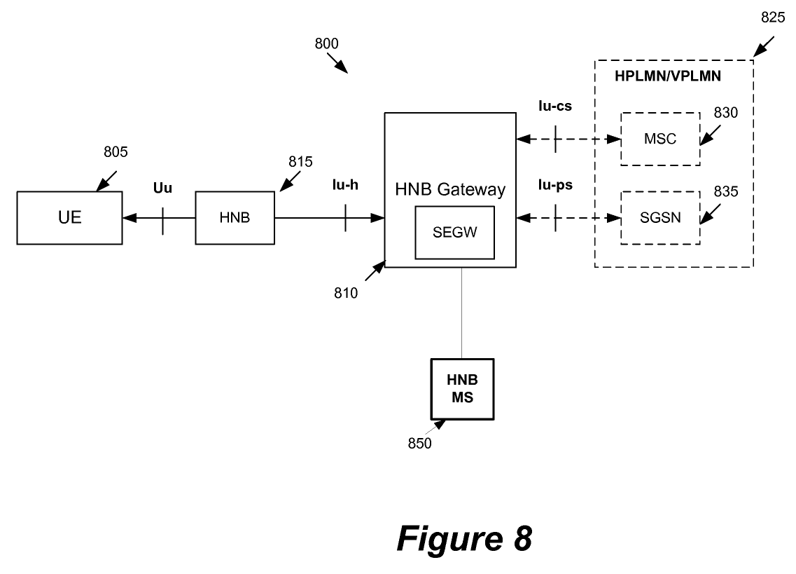

FIG. 8 illustrates the Home Node B Access Network (HNBAN) functional architecture of some embodiments. The HNBAN 800 includes one or more HNB-Gs 810 communicably coupled to one or more HNBs 815 through an Iu-h interface. In some embodiments, the Iu-h interface provides for standard RANAP messaging to be exchanged between the HNB-G 810 and HNB 815 with some or no encapsulation. One or more UEs 805 (one is shown for simplicity) can be communicably coupled to the HNB-G 810 through the HNB 815 using a Uu interface between the UE 805 and HNB 815. Similar to the GANC 610 of FIG. 6, the HNB-G 810 has the capability to appear to the core network 825 as a UMTS Terrestrial Radio Access Network (UTRAN) Radio Network Controller (RNC). In some embodiments, the HNB-G 810 includes a Security Gateway (not shown) that terminates secure remote access tunnels from the UE 805, providing mutual authentication with the HNB management system 850, encryption and data integrity for signaling, voice and data traffic.

A. ATM and IP Based Architectures

In some embodiments, the Femtocell system uses Asynchronous Transfer Mode (ATM) based Iu (Iu-cs and Iu-ps) interfaces towards the CN. In some embodiments, the Femtocell system architecture can also support an IP based Iu (Iu-cs and Iu-ps) interface towards the CN.

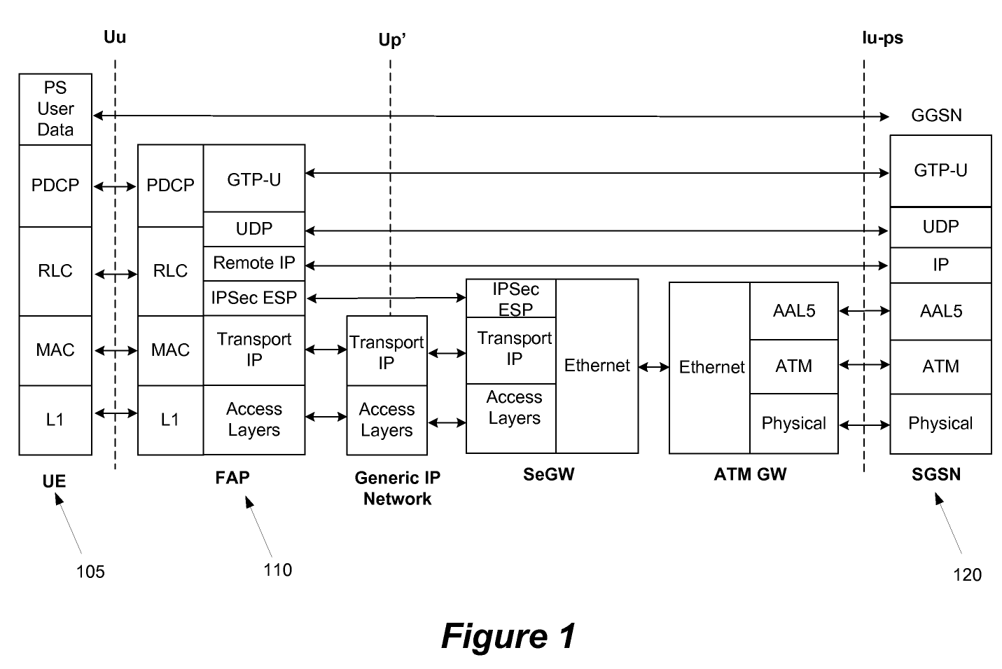

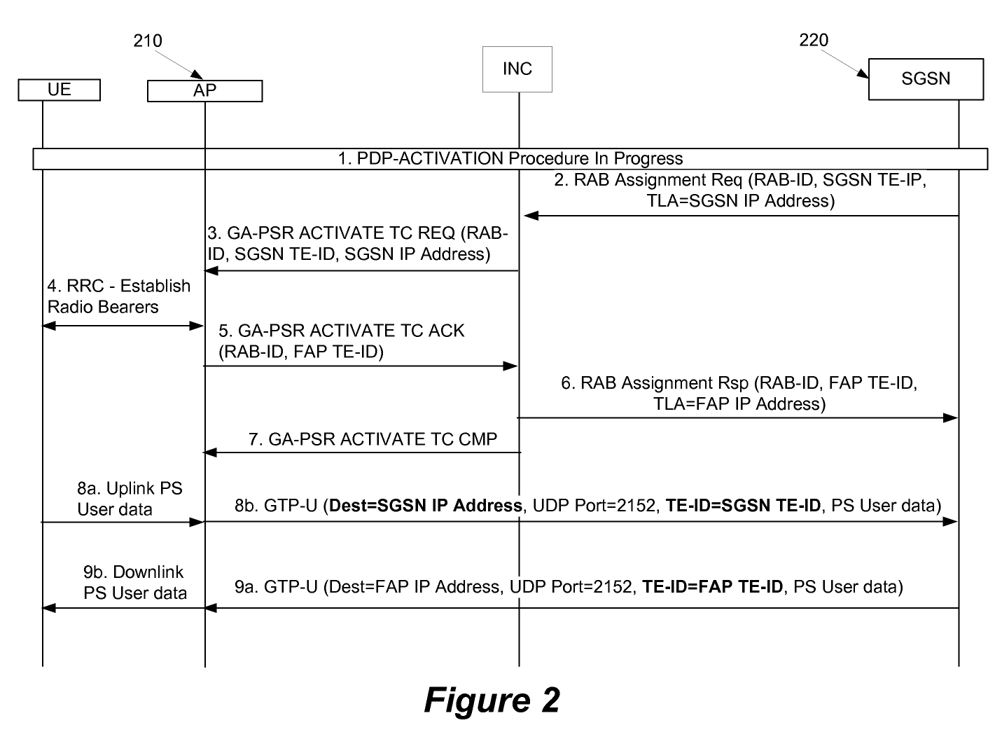

A person of ordinary skill in the art would realize that the same examples can be readily applied to other types of ICS. For instance, these examples can be used when the ICS access interface 110 (shown in FIG. 1) uses unlicensed frequencies (instead of Femtocell's licensed frequencies), the access point 314 is a generic WiFi access point (instead of a FAP), etc. Also, a person of ordinary skill in the art would realize that the same examples can be readily implemented using A/Gb interfaces (described above) instead of Iu interfaces.

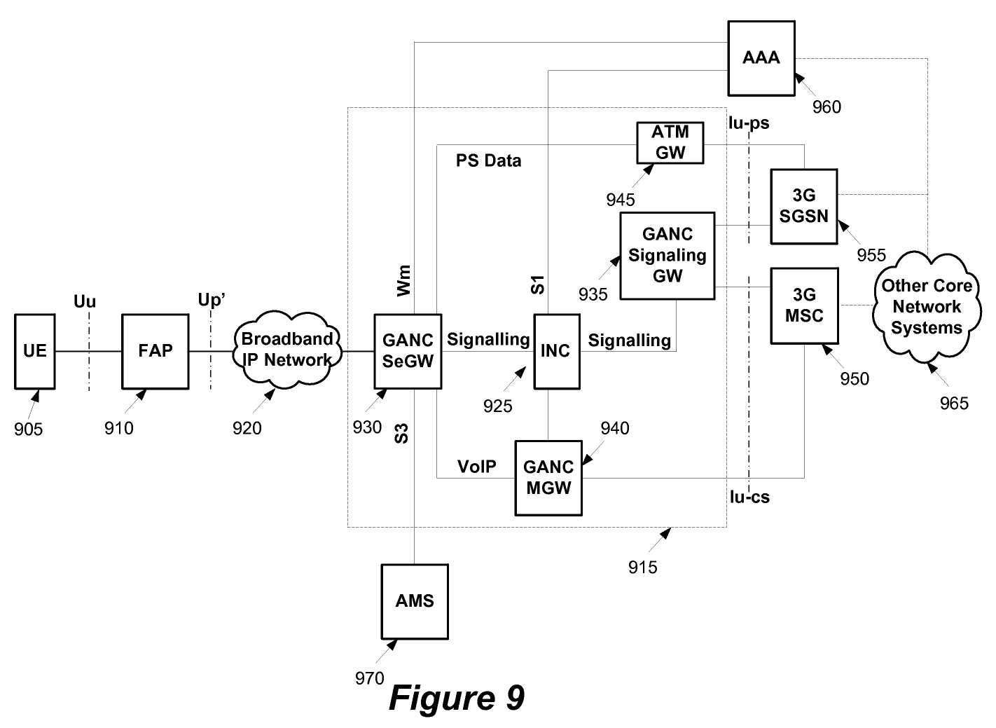

FIG. 9 illustrates the basic elements of the Femtocell system architecture with Asynchronous Transfer Mode (ATM) transport based Iu (Iu-cs and Iu-ps) interfaces towards the CN in some embodiments. These elements include the user equipment (UE) 905, the FAP 910, and the Generic Access Network Controller (GANC) 915, and the Access Point Management System (AMS) 970.

For simplicity, only one UE and one FAP are shown. However, each GANC can support multiple FAPs and each FAP in turn can support multiple UEs. As shown, the GANC 915 includes an IP Network Controller (INC) 925, a GANC Security Gateway (SeGW) 930, a GANC Signaling Gateway 935, a GANC Media Gateway (MGW) 940, an ATM Gateway (945). Elements of the Femtocell are described further below.

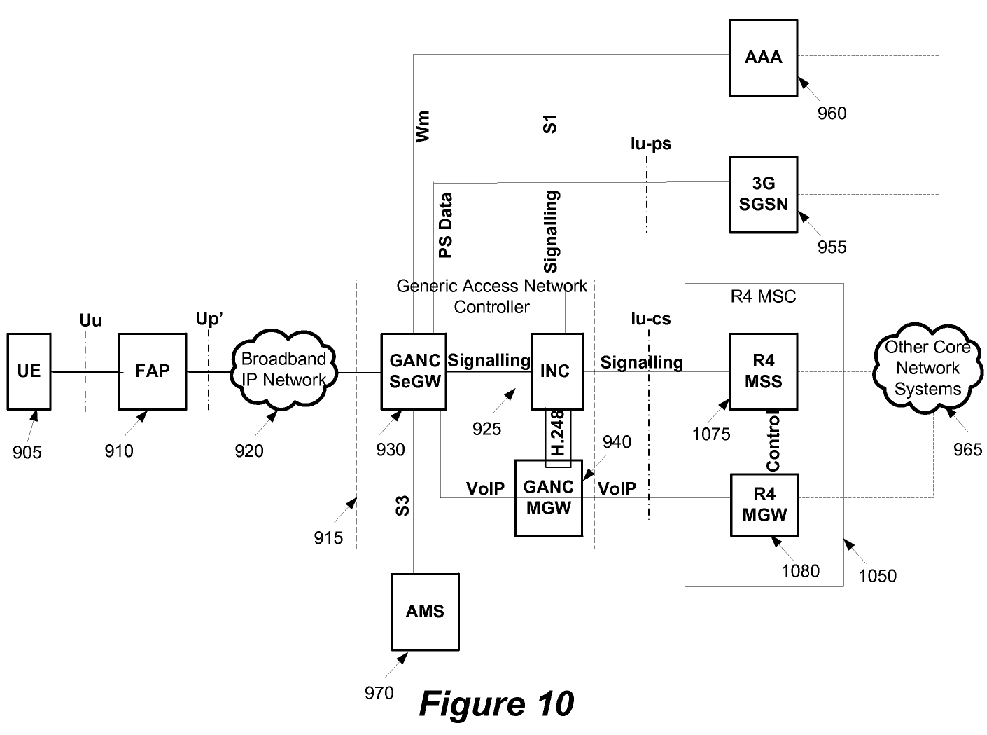

FIG. 10 illustrates the basic elements of the Femtocell system architecture with an IP based transport Iu (Iu-cs and Iu-ps) interface towards the CN in some embodiments. For simplicity, only one UE and one FAP are shown. However, each GANC can support multiple FAPs and each FAP in turn can support multiple UEs. This option eliminates the need for the GANC Signaling gateway 935 and also the ATM gateway 945. Optionally for IP based Iu interface, the GANC Media Gateway 940 can also be eliminated if the R4 MGW 1005 in the CN can support termination of voice data i.e. RTP frames as defined in “Real-Time Transport Protocol (RTP) Payload Format and File Storage Format for the Adaptive Multi-Rate (AMR) and Adaptive Multi-Rate Wideband (AMR-WB) Audio Codecs”, IETF RFC 3267, hereinafter “RFC 3267”.

Also shown in FIGS. 9 and 10 are components of the licensed wireless communication systems. These components are 3G MSC 950, 3G SGSN 955, and other Core Network System (shown together) 965. The 3G MSC 950 provides a standard Iu-cs interface towards the GANC. Another alternative for the MSC is shown in FIG. 10. As shown, the MSC 1050 is split up into a MSS (MSC Server) 1075 for Iu-cs based signaling and MGW 1080 for the bearer path. R4 MSC 1050 is a release 4 version of a 3G MSC with a different architecture i.e. R4 MSC is split into MSS for control traffic and a MGW for handling the bearer. A similar MSC can be used for the ATM architecture of FIG. 9. Both architectures shown in FIGS. 9 and 10 are also adaptable to use any future versions of the MSC.

The 3G SGSN 955 provides packet services (PS) via the standard Iu-ps interface. The SGSN connects to the INC 925 for signaling and to the SeGW 930 for PS data. The AAA server 960 communicates with the SeGW 930 and supports the EAP-AKA and EAP-SIM procedures used in IKEv2 over the Wm interface and includes a MAP interface to the HLR/AuC. This system also supports the enhanced service access control functions over the S1 interface.

For simplicity, in several diagrams throughout the present application, only the INC component of the GANC is shown. Also, whenever the INC is the relevant component of the GANC, references to the INC and GANC are used interchangeably.

B. Functional Entities

1. User Equipment (UE)

The UE includes the functions that are required to access the Iu-mode GAN or Iu-mode HNBAN. In some embodiments, the UE additionally includes the functions that are required to access the A/Gb-mode GAN. In some embodiments, the User Equipment (UE) is a dual mode (e.g., GSM and unlicensed radios) handset device with capability to switch between the two modes. The user equipment can support either Bluetooth® or IEEE 802.11 protocols. In some embodiments, the UE supports an IP interface to the access point. In these embodiments, the IP connection from the GANC extends all the way to the UE. In some other embodiments, the User Equipment (UE) is a standard 3G handset device operating over licensed spectrum of the provider.

In some embodiments, the user equipment includes a cellular telephone, smart phone, personal digital assistant, or computer equipped with a subscriber identity mobile (SIM) card for communicating over the licensed or unlicensed wireless networks. Moreover, in some embodiments the computer equipped with the SIM card communicates through a wired communication network.

Alternatively, in some embodiments the user equipment includes a fixed wireless device providing a set of terminal adapter functions for connecting Integrated Services Digital Network (ISDN), Session Initiation Protocol (SIP), or Plain Old Telephone Service (POTS) terminals to the ICS. Application of the present invention to this type of device enables the wireless service provider to offer the so-called landline replacement service to users, even for user locations not sufficiently covered by the licensed wireless network. Moreover, some embodiments of the terminal adapters are fixed wired devices for connecting ISDN, SIP, or POTS terminals to a different communication network (e.g., IP network) though alternate embodiments of the terminal adapters provide wireless equivalent functionality for connecting through unlicensed or licensed wireless networks.

2. Femtocell Access Point (FAP)

As noted above, a FAP is a licensed access point that offers a standard radio interface (Uu) for UE connectivity. The FAP provides radio access network connectivity for the UE using a modified version of the standard GAN interface (Up). In some embodiments, the FAP is equipped with either a standard 3G USIM or a 2G SIM.

In accordance with some embodiments, the FAP 910 will be located in a fixed structure, such as a home or an office building. In some embodiments, the service area of the FAP includes an indoor portion of a building, although it will be understood that the service area may include an outdoor portion of a building or campus.

In some of the following discussion and some of the subsequent figures, the term AP will interchangeably refer to an unlicensed wireless access point, FAP, or HNB. This interchanging of terms is for purposes of simplifying the following discussion and is not intended to limit the discussion to apply to only an AP of a UMA network, FAP of a Femtocell network, or HNB of a HNBAN.

3. Generic Access Network Controller (GANC)

The GANC 710 is an enhanced version of the GANC defined in “Generic access to the A/Gb interface; Stage 2”, 3GPP TS 43.318 standard, hereinafter “TS 43.318 standard”. The GANC appears to the core network as a UTRAN Radio Network Controller (RNC). The GANC includes a Security Gateway (SeGW) 720 and IP Network Controller (INC) 765. In some embodiments (not shown in FIG. 7), the GANC also includes GANC Signaling Gateway 735, a GANC Media Gateway (MGW) 940, and/or an ATM Gateway (945).

The SeGW 720 provides functions that are defined in TS 43.318 standard and “Generic access to the A/Gb interface; Stage 3”, 3GPP TS 44.318 standard. The SeGW terminates secure access tunnels from the FAP, providing mutual authentication, encryption and data integrity for signaling, voice and data traffic. The SeGW 720 is required to support EAP-SIM and EAP-AKA authentication for the FAP 760.

The INC 765 is the key GANC element. In some embodiments, the INC is front-ended with a load balancing router/switch subsystem which connects the INC to the other GAN systems; e.g., GANC security gateways, local or remote management systems, etc.

The GANC MGW 940 provides the inter-working function between the Up interface and the Iu-CS user plane. The GANC MGW would provide inter-working between RFC 3267 based frames received over the Up interface and Iu-UP frames towards the CN. The GANC Signaling GW 935 provides protocol conversion between SIGTRAN interface towards the INC and the ATM based Iu-cs interface towards the CN. The ATM GW 945 provides ATM/IP gateway functionality, primarily routing Iu-ps user plane packets between the SeGW (IP interface) and CN (AAL5 based ATM interface).

In some of the following discussion and some of the subsequent figures, the term GANC will interchangeably refer to either the GANC of a GAN, HNB-G of a HNBAN, or UNC of a UMA system. This interchanging of terms is for purposes of simplifying the following discussion and is not intended to limit the discussion to apply to only a GANC of a GAN, UNC of a UMA network, or HNB-G of a HNBAN. Moreover, it should be apparent to one of ordinary skill in the art that the GANC, UNC, or HNB-GW of some embodiments need not represent a single physical hardware entity, but a functional collection of components that logically act as an ICS network controller. For instance, a GANC of some embodiments may logically represent a collection of some or all of the INC 765, SeGW 720, Signaling Gateway 735, MGM 940, 945, or other network components.

4. Broadband IP Network

The Broadband IP Network 715 represents all the elements that collectively, support IP connectivity between the GANC SeGW 720 function and the FAP 760. This includes: (1) Other Customer premise equipment (e.g., DSL/cable modem, WLAN switch, residential gateways/routers, switches, hubs, WLAN access points), (2) Network systems specific to the broadband access technology (e.g., DSLAM or CMTS), (3) ISP IP network systems (edge routers, core routers, firewalls), (4) Wireless service provider (WSP) IP network systems (edge routers, core routers, firewalls), and (5) Network address translation (NAT) functions, either standalone or integrated into one or more of the above systems.

5. AP Management System (AMS)

The AMS 770 is used to manage a large number of FAPs 760 including configuration, failure management, diagnostics, monitoring and software upgrades. The access to AMS functionality is provided over secure interface via the GANC SeGW 720.

Some embodiments of the above mentioned devices, such as the user equipment, access points (e.g., FAP, HNB, etc), and network controllers (e.g., GANC, HNB-G, UMA network controller, etc.) include electronic components, such as microprocessors and memory (not shown), that store computer program instructions (such as instructions for executing wireless protocols for managing voice and data services) in a machine-readable or computer-readable storage medium as further described below in the section labeled “Computer System”. Examples of machine-readable media or computer-readable media include, but are not limited to magnetic media such as hard disks, memory modules, magnetic tape, optical media such as CD-ROMS and holographic devices, magneto-optical media such as optical disks, and hardware devices that are specially configured to store and execute program code, such as application specific integrated circuits (ASICs), programmable logic devices (PLDs), ROM, and RAM devices. Examples of computer programs or computer code include machine code, such as produced by a compiler, and files including higher-level code that are executed by a computer, an electronic component, or a microprocessor using an interpreter.

### III. PACKET SWITCHED CONTROL AND USER PLANE ARCHITECTURE

The following sections describe the control and user plane architectures for the Packet Switched (PS) domain of some embodiments through which data services are provided.

A. PS Domain—Control Plane

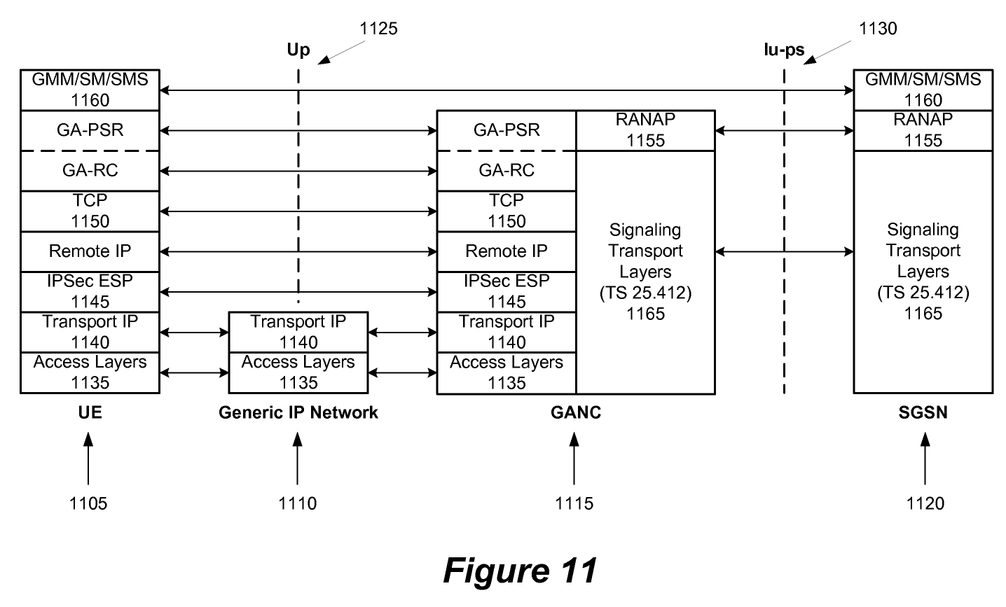

FIG. 11 illustrates a GAN architecture in support of the PS Domain Control plane in accordance with some embodiments. The figure shows different protocol layers for the UE 1105, Generic IP Network 1110, GANC 1115, and SGSN 1120. FIG. 11 also shows the two interfaces Up 1125 and Iu-ps 1130. The main features of the GAN PS domain control plane architecture shown in FIG. 11 are as follows. The underlying Access Layers 1135 and Transport IP layer 1140 provide the generic connectivity between the UE 1105 and the GANC 1115. The IPSec layer 1145 provides encryption and data integrity. TCP 1150 provides reliable transport for the Generic Access Packet Switched Resource (GA-PSR) between UE 1105 and GANC 1115. The GA-RC manages the IP connection, including the GAN registration procedures. The GA-PSR protocol supports UMTS-specific requirements.

The GANC 1115 terminates the GA-PSR protocol and inter-works it to the RANAP protocol 1155 over the Iu-ps interface 1130. NAS protocols 1160, such as for GMM, SM and SMS, are carried transparently between the UE 1105 and SGSN 1120. In some embodiments, the Iu-ps signaling transport layers 1165 are per 3GPP TS 25.412.

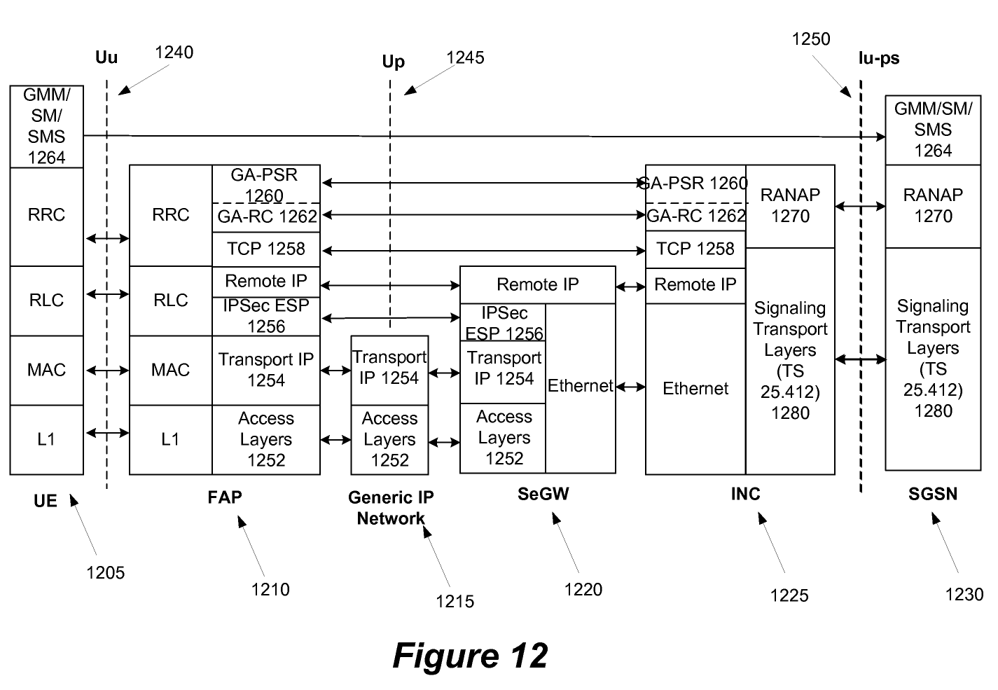

FIG. 12 illustrates the GAN Femtocell architecture of some embodiments in support of the PS Domain Control Plane. The figure shows different protocol layers for the UE 1205, FAP 1210, Generic IP Network 1215, SeGW 1220, INC 1225, and SGSN 1230. FIG. 12 also shows the three interfaces Uu 1240, Up 1245, and Iu-ps 1250.

The main features of the Up interface 1245 for the PS domain control plane are as follows. The underlying Access Layers 1252 and Transport IP layer 1254 provide the generic connectivity between the FAP 1210 and the GANC. The IPSec layer 1256 provides encryption and data integrity.

TCP 1258 provides reliable transport for the GA-PSR 1260 signaling messages between FAP 1210 and GANC. The GA-RC 1262 manages the IP connection, including the Femtocell registration procedures. The GA-PSR 1260 protocol performs functionality equivalent to the UTRAN RRC protocol.

Upper layer protocols 1264, such as for GMM, SM and SMS, are carried transparently between the UE 1205 and CN. The GANC terminates the GA-PSR 1260 protocol and inter-works it to the Iu-ps interface 1250 using RANAP 1270. In some embodiments, the Iu-ps signaling transport layers 1280 are per TS 25.412.

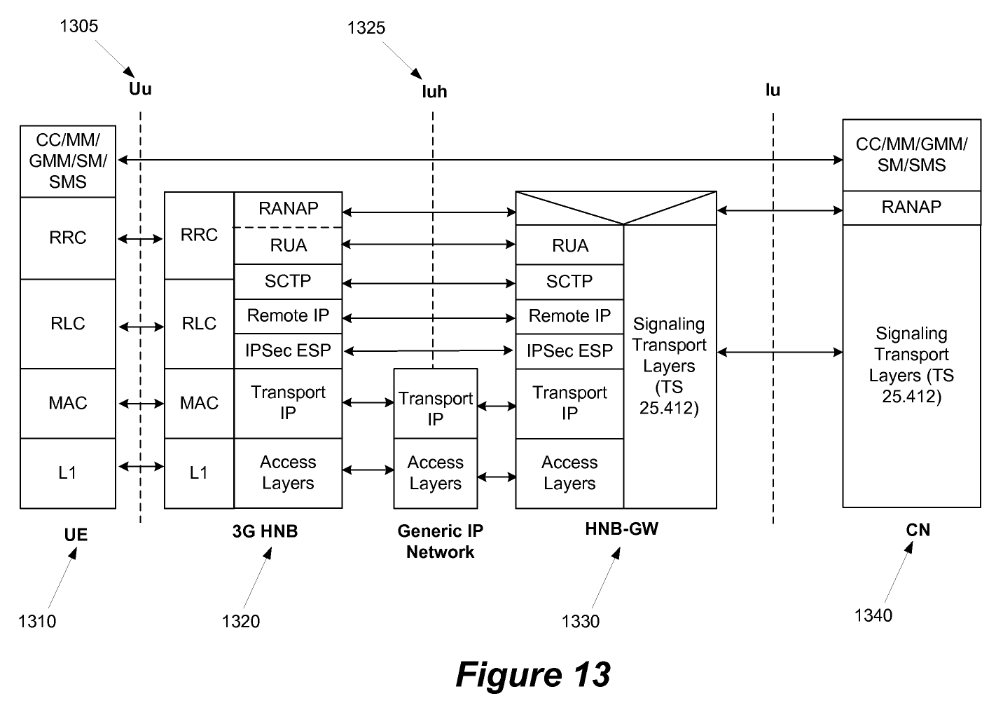

FIG. 13 illustrates the HNBAN architecture of some embodiments in support of the PS/CS Domain Control Plane. In FIG. 13, the Uu interface is used in communications between the UE 1310 and the HNB 1320 and the Iu-h interface is used in communications between the HNB 1320 and the HNB-GW 1330. The protocol stack for the HNB 1320 is similar to the protocol stack of the FAP 1210 in FIG. 12 when the HNB 1320 communicates with the UE 1310. However, the top level protocols used in communicating with the HNB-GW 1330 and the core network 1340 utilize RANAP, RUA (RANAP User Adaption), and SCTP protocols instead of GA-PSR, GA-RC, and TCP as shown in FIG. 12. In this figure, a single SCTP association is established between the HNB 1320 and the HNB-GW. The same SCTP association is used for the transport of both the HNBAP messages as well as the RANAP messages over the Iu-h interface 1325.

B. PS Domain—User Plane

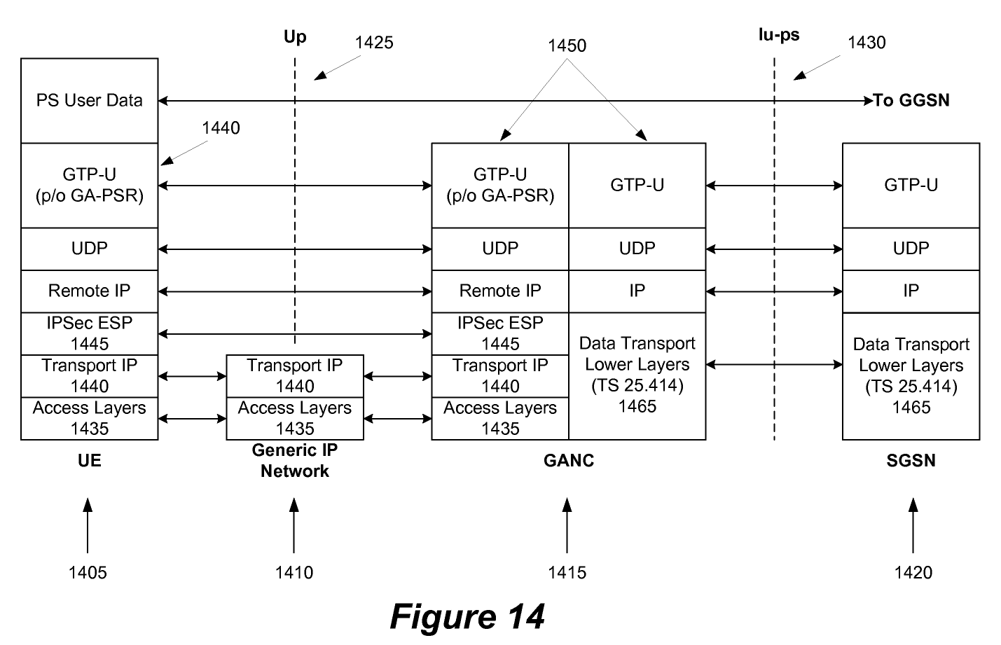

FIG. 14 illustrates a GAN architecture for the PS Domain User Plane in some embodiments. The figure shows different protocol layers for the UE 1405, Generic IP Network 1410, GANC 1415, SGSN 1420. FIG. 14 also shows the two interfaces Up 1425 and Iu-ps 1430. The main features of the GAN PS domain user plane architecture shown in FIG. 14 are as follows. The underlying Access Layers 1435 and Transport IP layer 1440 provide the generic connectivity between the UE 1405 and the GANC 1415. The IPSec layer 1445 provides encryption and data integrity.

GA-PSR is extended to include support for the GTP-U G-PDU message format to transport PS User Data (e.g., IP packets), rather than LLC PDUs as in A/Gb mode GAN. As such, the IP based GTP protocols of the GSM and UMTS networks are employed within the GAN. In this configuration, the GANC 1415 terminates the Up interface GTP-U tunnel with the UE 1405 and also terminates the separate Iu-ps GTP-U tunnel to the SGSN 1420. Each UE 1405 will have one or more such tunnels, one for each Packet Data Protocol (PDP) context that is active and possibly separate tunnels for specific connections with different Quality of Service requirements. The GANC 1415 relays the PS user data between the Up interface GTP-U tunnel and the associated Iu-ps interface GTP-U tunnel to allow the PS user data to flow between the UE and the SGSN.

Accordingly, each of the GANC 1415 and UE 1405 of some embodiments include a GTP-U protocol entity (e.g., 1440 illustrates the GTP-U protocol entity of the UE 1405 and 1450 illustrates the GTP-U protocol entity of the GANC 1415) that provides the packet transmission and reception services for the device.

Specifically, the GTP-U protocol entity 1450 in the GANC 1415 provides packet transmission services and reception services to user plane entities in the UE 1405 and in the GGSN, SGSN (e.g., 1420), or RNC. The GTP-U protocol entity 1450 receives traffic from a number of GTP-U tunnel endpoints and transmits traffic to a number of GTP-U tunnel endpoints. There is a GTP-U protocol entity per IP address.

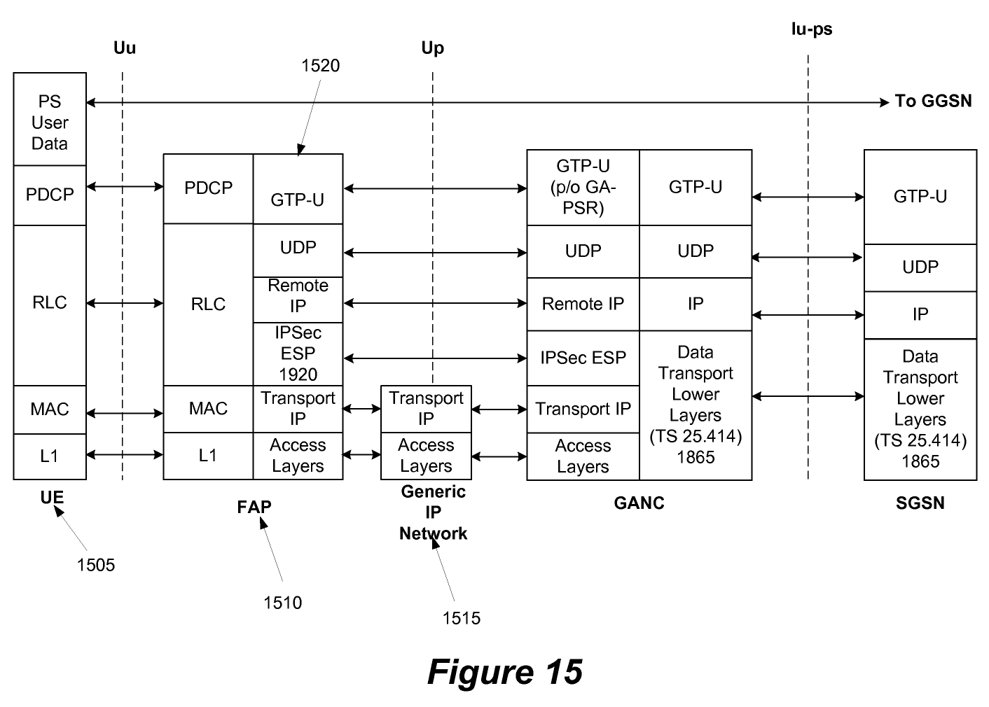

A person of ordinary skill in the art would realize that other user equipments, access point, terminal adaptor, SoftMobiles, etc. can be connected to the core network through a GANC. For instance, FIG. 15 illustrates a PS domain, user plane protocol architecture of a UE 1505, a Femtocell access point (FAP) 1510, and Generic IP Network 1515. A person of ordinary skill in the art would be able to replace the UE 1405 and Generic IP Network 1410 shown in FIG. 14 with the UE 1505, FAP 1510, and Generic IP Network 1515 to connect the Femtocell UE 1505 to the core network through the GANC. In some such embodiments, the FAP 1510 includes a GTP-U protocol entity 1520 to provide the above described functionality and to act as a tunnel endpoint for data services of the UE 1505.

### IV. SUPPORTING LARGE NUMBER OF PATHS OVER REDUCED SET OF PATHS

In some embodiments, data paths are established through the control plane. These data paths are used to carry user data from one or more user equipment operating in the service regions of an ICS to a core network. Specifically, the data paths of some embodiments securely transmit data between a UE or AP operating within the ICS and a SGSN or GGSN of a core network. In some embodiments, the data paths are GTP-U paths that include one or more GTP-U tunnels.

At each endpoint of a tunnel, data is encapsulated within packet GTP-U PDUs (G-PDUs). Each G-PDU includes a GTP header and a T-PDU for the payload that is tunneled in the GTP tunnel. The GTP header includes a tunnel endpoint identifier (TE-ID) that indicates which tunnel a particular T-PDU belongs to. In this manner, packets are multiplexed and de-multiplexed by GTP-U between a given pair of tunnel endpoints.

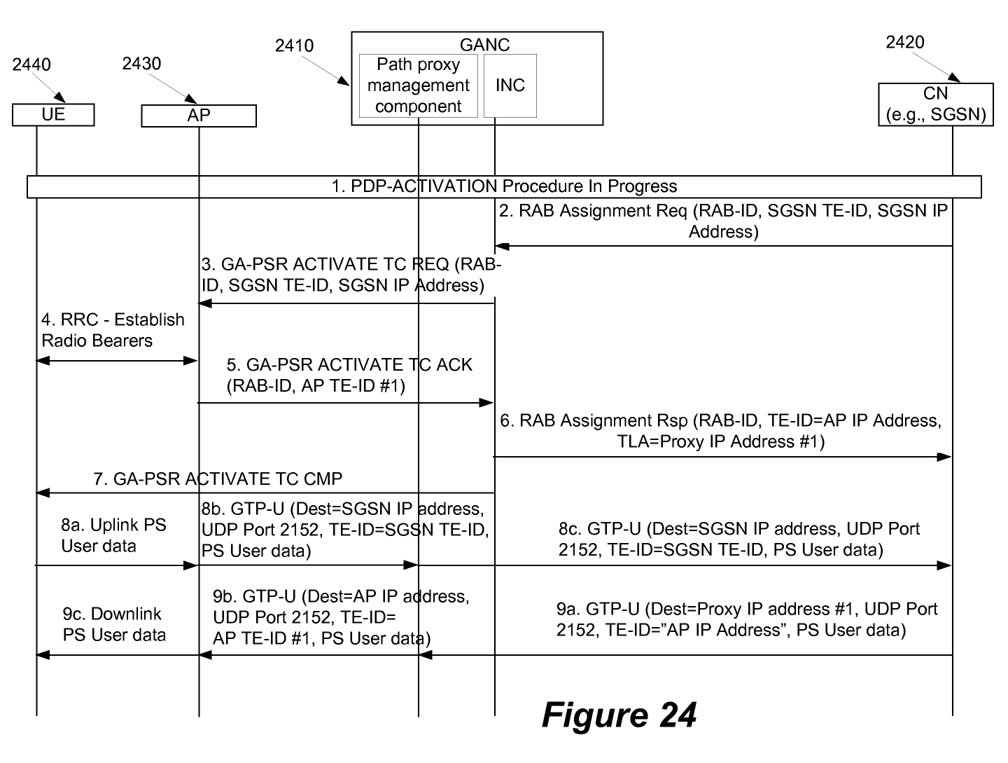

Specifically, the TE-ID in the GTP header is used to de-multiplex traffic incoming from remote tunnel endpoints so that it is delivered to the correct user plane entities in a way that allows multiplexing of different users, different packet protocols, and different Quality of Service (QoS) levels. Therefore, no two remote GTP-U endpoints shall send traffic to a GTP-U protocol entity using the same TE-ID value except for data forwarding as part of a Serving Radio Network Subsystem (SRNS) relocation or intersystem change procedures as specified in “GPRS Tunnelling Protocol (GTP) across the Gn and Gp interface”, 3GPP TS 29.060. In some embodiments, the TE-ID value shall be negotiated during a GTP-C Create PDP Context and RAB assignment procedures that take place on the control plane as described in further detail below with reference to FIG. 24.

In some embodiments, an access point (AP) that acts as one of the endpoints for the data path includes a tall-based stack (e.g., FAP, HNB, etc.) that provides additional services to that of generic IP connectivity. The AP has a unique IP address that identifies a source for uplink data packets (i.e., data packets sent from an UE or AP to the core network) and that identifies a destination for downlink data packets (i.e., data packets sent from the core network to an UE or AP).

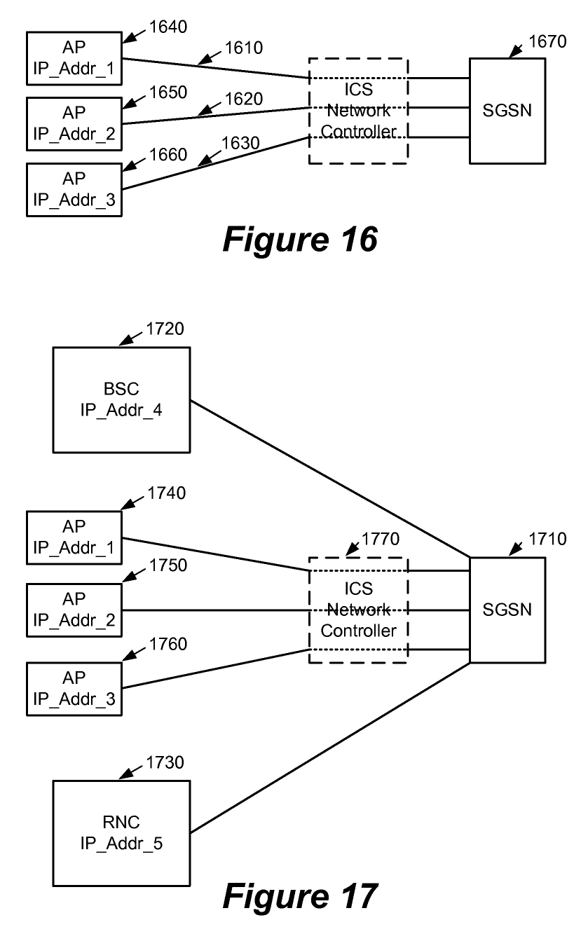

FIG. 16 illustrates multiple data paths 1610-1630 established between different APs 1640-1660 of an ICS and a SGSN 1670 of a core network. In this figure, the data paths 1610-1630 represent GTP tunnels over which data packets are exchanged with the SGSN 1670. In some embodiments, these GTP tunnels facilitate different data services for a UE operating within the service region of the AP. The different data services include a web browsing session, an instant messaging session, and a MMS message exchange as some examples. Additionally, these GTP-U tunnels facilitate different data services for different UEs that operate within a service region of the AP.

Integration of a large number of such APs into the core network could quickly overwhelm the resources of a SGSN as one or more different GTP paths will be required for each such AP. Some SGSNs currently in deployment cannot support more than 4096 RNCs in a given PLMN with each AP of an ICS emulating functionality of an RNC. FIG. 17 illustrates integrating APs of an ICS with a SGSN of a core network that services RNCs and BSCs of other licensed wireless networks.

In this figure, the SGSN 1710 facilitates data services through GTP paths established between a BSC 1720 of a GSM network, a RNC 1730 of a UMTS network, and APs 1740, 1750, and 1760 of an ICS (e.g., GAN). As shown, each of the APs 1740, 1750, and 1760 terminate a GTP tunnel established with the SGSN 1710 with the network controller 1770 (e.g., GANC) being transparent to the tunnels. Since an ICS may have many hundreds if not thousands of APs serviced by one or more network controllers, the number of GTP paths required to integrate the ICS into the core network results in a large and disproportionate usage of the resources of the core network. As a result, the SGSN 1710 can be overwhelmed by the large number of APs. Specifically, the SGSN 1710 may not be able to scale to support the number of GTP paths required by a heavily utilized ICS with numerous subscribers connecting to the ICS through their own home or office based AP. This can lead to data services provided by the core network becoming unavailable or detrimentally affected. It should be apparent to one of ordinary skill in the art that such problems exist for integration of any ICS system, such as GAN, UMA, Femtocell, or HNBAN, into the core network.

These limitations may be overcome by changes to components of the core network (e.g., updating the SGSN to handle a larger number of paths, disable path management, or separate path management IP address from the actual packet switched user data IP address at the SGSN). However, implementing such solutions within the core network is costly as change or upgrades will be required to a large scale infrastructure of already deployed components. Moreover, the onus and cost resulting from the integration of the GAN would be passed to operators of the core network, creating a disincentive for the core network to adopt the ICS functionality.

Therefore, some embodiments of the invention reduce the impact of integrating the ICS with the core network by providing support for a large number of GTP-U paths terminated between the APs and network controller of the ICS through a smaller set of GTP-U paths terminated between the network controller and a data service providing component of the core network (e.g., SGSN or GGSN). In this manner, some embodiments accelerate the deployment and integration of ICS based services.

To integrate such functionality with little to no impact to the core network, some embodiments of the invention incorporate path termination functionality and path mapping functionality into the network controller of the ICS. However, it should be apparent to one of ordinary skill in the art that such functionality may be provided via a path proxy management component (i.e., GTP-U proxy or GTP-U Relay) that is a separate software module that compliments the functionality of already deployed network controllers or that operates independent of the network controller. Additionally, the path proxy management component of some embodiments is a separate hardware module that operates as a module within a network controller of a GAN or is a separate hardware module apart from the network controller with its own receiver and transceiver for receiving and transmitting messages to and from the network controller, AP, or core network (e.g., SGSN).

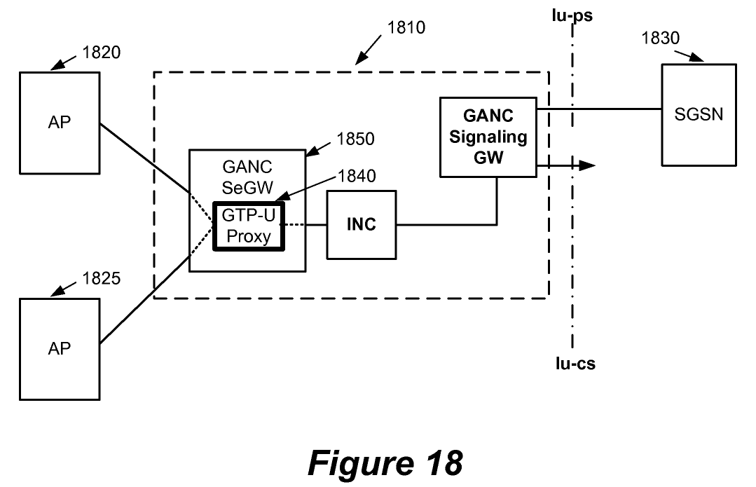

FIG. 18 provides a first manner of integrating path termination and path mapping functionality of some embodiments into a GANC 1810. In this figure, the GANC 1810 terminates (1) a set of GTP paths established between APs 1820 and 1825 and the GANC 1810 and (2) terminates a GTP path established between a SGSN 1830 of the core network and the GANC 1810 over which data packets from the APs 1820 and 1825 are routed to the core network. Specifically, the GANC 1810 includes a path proxy management component 1840 that performs some of the path termination and path mapping functionality for the GANC 1810 as described below in Subsection A. In some embodiments, the path proxy management component 1840 provides the smaller set of GTP paths for the SGSN 1830, responds to path messages from the SGSN 1830, maintains a mapping of TE-IDs to AP IP addresses for downlink packets (as further described below), and optionally masks real SGSN IP addresses towards the AP by using one-to-one static NAT functionality as an example.

As shown, the path proxy management component 1840 is integrated within the security gateway component 1850 of the GANC. Accordingly, the larger set of paths established between the APs 1820 and 1825 and the GANC 1810 are terminated at the security gateway 1850 instead of being terminated at the SGSN 1830 and the smaller set of paths that are established and terminated between the GANC 1810 and the SGSN 1830 are used to route data from the larger set of data paths to the core network.

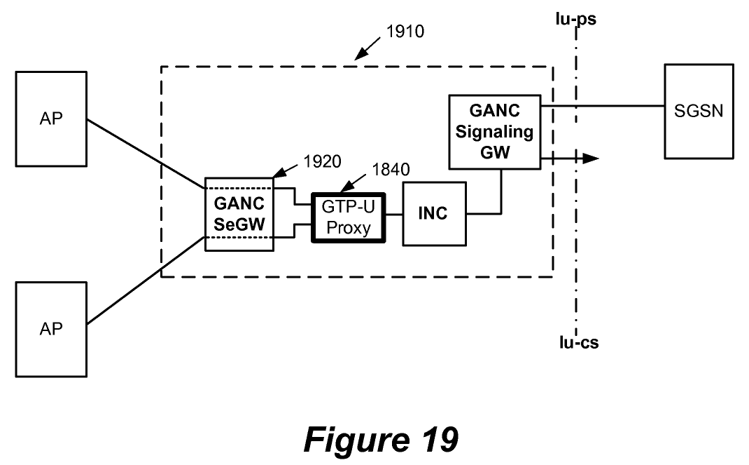

FIG. 19 provides a second manner of integrating path termination and path mapping functionality of some embodiments into a GANC 1910. In this figure, the path proxy management component 1840 is a separate node behind the security gateway 1920. In such embodiments, the paths pass through the security gateway 1920 of the GANC 1910 before being terminated at the path proxy management component 1840. It should be apparent to one of ordinary skill in the art that in some embodiments the security gateway 1920 is a functional component that is separate from the GANC 1910. In some such embodiments, the path proxy management component 1840 is also a functional component that is separate from the GANC 1910.

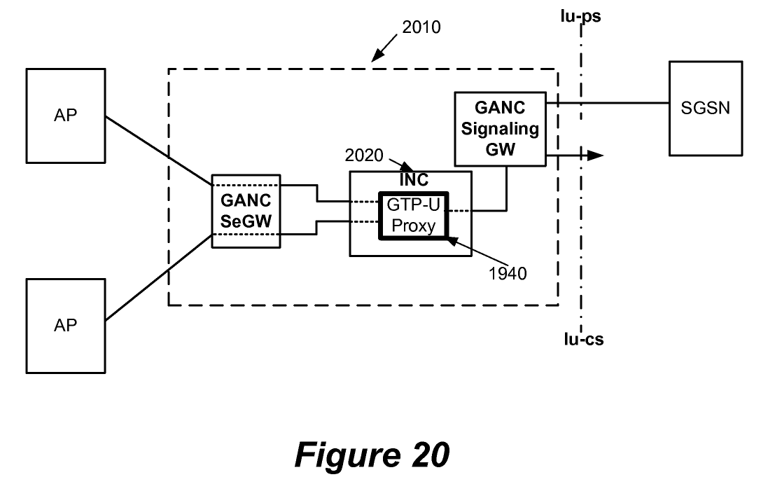

FIG. 20 provides a third manner of integrating path termination and path mapping functionality of some embodiments into a GANC 2010. In this figure, the path proxy management component 1840 is within the INC 2020 of the GANC 2010.

FIGS. 18-20 illustrate various levels of integration of the path proxy management component with a GANC of some embodiments. Though FIGS. 18-20 are described in relation to a GANC, it should be apparent to one of ordinary skill in the art that the path proxy management component can similarly be made a component of a network controller of any ICS based system. Additionally, it should be apparent to one of ordinary skill in the art that the path proxy management component may be physically or logically separate from the network controller and can therefore be integrated with network controllers of an ICS that have already been deployed into the field of use.

Specifically, in some embodiments, the path proxy management component 1840 is a software component of the network controller that resides on a computer readable medium of the network controller and that is executed by one or more processors of the network controller. In some embodiments, the path proxy management component 1840 is a hardware device that operates in conjunction with or independent of the network controller, where the hardware device includes its own computer readable medium storing instructions for performing the path termination and path mapping functionality by one or more processors of the hardware device.

A. Overview

Section III above illustrates some of the different ICS PS domain architectures that reduce the number of paths established between the ICS and the core network for a larger set of paths established internally between a network controller and a set of APs of the ICS. For example, in the configuration of FIG. 14, the GANC 1415 terminates the Up interface GTP-U tunnel with the UE 1405 and also terminates the separate Iu-ps GTP-U tunnel to the SGSN 1420. In the configuration of FIG. 15, the GANC terminates the Up interface GTP-U tunnel with the FAP 1510 and also terminates the separate Iu-ps GTP-U tunnel to the core network 1340. In both configurations, the network controllers relay the PS user data between the UE or AP established GTP-U tunnel and the associated Iu-ps interface GTP-U tunnel to allow the PS user data to flow between the UE and the core network. These configurations minimize the number of active GTP-U paths presented to the core network by establishing only a smaller set of data paths with the SGSN as opposed to the larger set of data paths terminated between the network controllers and the UEs or APs.

The description below provides two embodiments for the path termination and path mapping functionality of some embodiments between a tall based stack AP and a network controller (e.g., GANC) of an ICS. In other words, such functionality is implemented in some embodiments, between any tall based stack AP and network controller of a UMA, GAN, Femtocell, HNBAN, or other ICS adaptable network. Accordingly, such functionality may be implemented across the various protocols and interfaces used in communications between such devices. For example, the Up interface is used between a FAP and GANC. However, it should be apparent to one of ordinary skill in the art the Up interface may be replaced with an equivalent interface, such as the Iu-h interface or any other interface used between an AP (e.g., HNB, FAP, H(e)NB, etc.) of an ICS and a network controller of the ICS (e.g., HNB-GW, GANC, H(e)NB-GW, etc.). Additionally, it should be apparent to one of ordinary skill in the art that such functionality may also be performed between any UE and network controller of a UMA, GAN, Femtocell, HNBAN, or other ICS adaptable network.

B. Fixed Proxy Mapping

To perform the path mapping, some embodiments configure the GANC and the path proxy management component with a set of proxy IP addresses to be used by one or more SGSNs as destination IP addresses for downlink GTP-U packets. This set of proxy IP addresses is a number from 1 to N, where N is the maximum number of simultaneous GTP-U paths that can be present at any single AP. Furthermore, each AP is configured to select a TE-ID value during RAB assignment that is within the range of N number of simultaneous GTP-U paths.

In some embodiments, the TE-ID selected by the AP is used by the GANC and/or path proxy management component to index into the set of proxy IP addresses in order to retrieve a corresponding proxy IP address. In a subsequent RAB assignment response, the GANC forwards the indexed proxy IP address to the SGSN while replacing the TE-ID with the actual IP address of the AP.

The opposite mapping is performed for downlink GTP-U packets sent from the SGSN to the AP. In such cases, the destination IP address of the downlink packet is replaced with the TE-ID that contains the actual IP address of the AP and the TE-ID is replaced with a fixed index of the proxy IP address. The table below illustrates an example of an IP address index to proxy IP address mapping table that some embodiments of the GANC and path proxy management component are configured with.

| IP Address Index | Proxy IP Address |
|---|---|
| 1 | 192.168.1.1 |
| 2 | 192.168.1.2 |
| 3 | 192.168.1.3 |
| 4 | 192.168.1.4 |

More specifically, the GTP-U path proxy management component maintains a flow-cache/mapping memory necessary for the IP address translation in the PS user place (i.e., uplink and downlink GTP-U packets). In some embodiments, the flow-cache/mapping maintained in the GTP-U path proxy management component contains:

| | | | | | | |
|---|---|---|---|---|---|---|
| SGSN IP | SGSN | AP IP | AP TE-ID | Virtual/Proxy | Virtual/Proxy | Virtual |
| Address | TE-ID | Address | | AP Address | AP TE-ID | SGSN IP |
| | | | | | | Address |

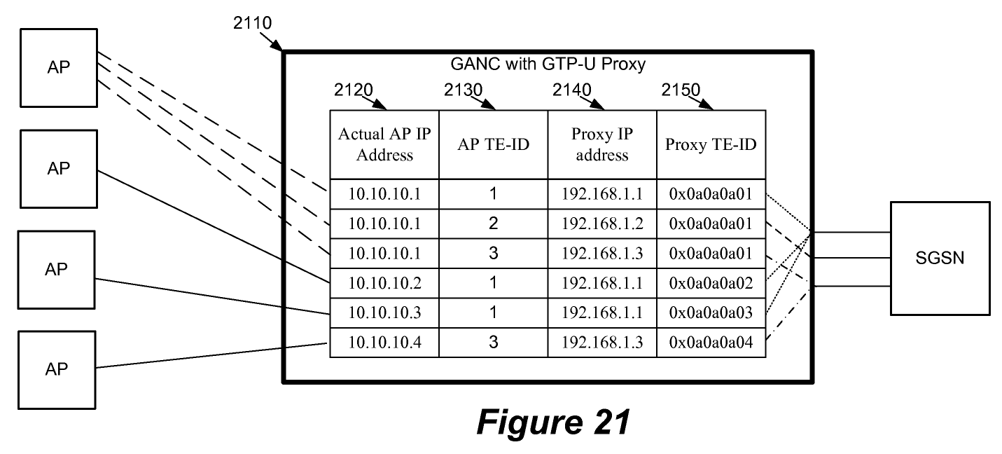

FIG. 21 illustrates a path mapping table 2110 utilized by a GANC of some embodiments to reduce the number of GTP-U paths needed between the GANC and a core network when routing data packets from a larger set of paths of GTP-U paths established between the GANC and GAN APs to the core network. The table 2110 includes (1) a set of actual AP IP addresses 2120, (2) TE-IDs 2130 associated with each of the data paths from the APs, and (3) a corresponding mapped set of proxy IP addresses 2140 and proxy TE-IDs 2150 used in reducing the number of paths established with the core network to facilitate data services for the larger set of data paths represented by the actual IP addresses 2120 and TE-IDs 2130.

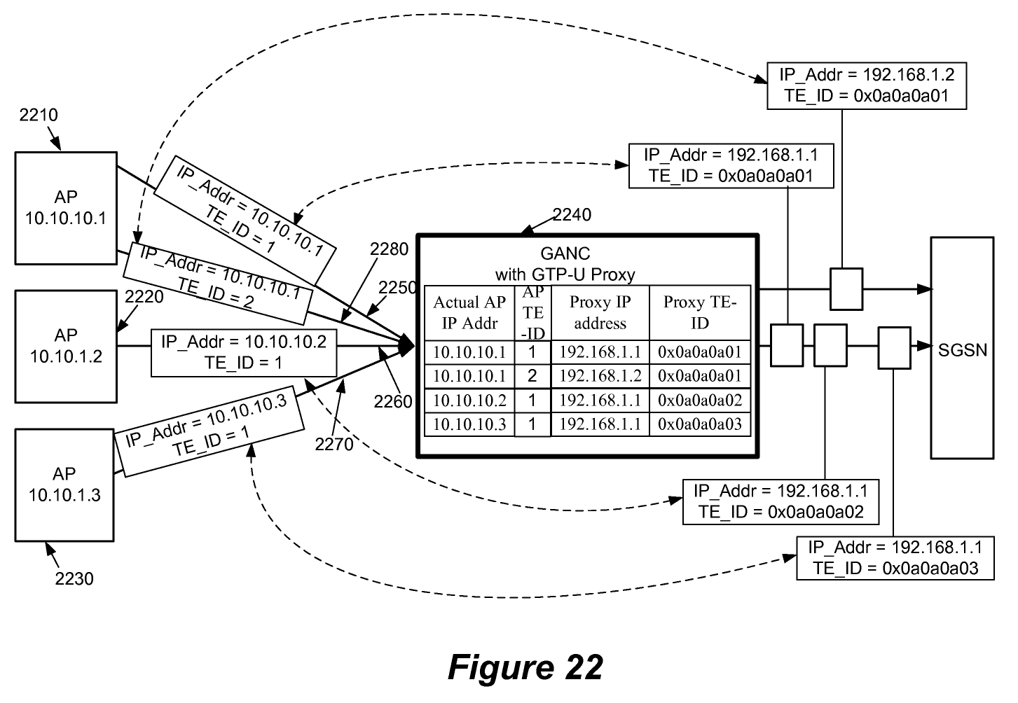

FIG. 22 illustrates a network controller of some embodiments performing the mapping between the larger set of data paths established with the APs and the smaller set of data paths established with the core network. In this figure, three APs 2210-2230 establish GTP paths with a GANC 2240 of some embodiments. Specifically, AP 2210 establishes two distinct GTP-U tunnels 2250 and 2280 with a separate TE-ID allocated for each tunnel, and APs 2220 and 2230 each establish a single tunnel 2260 or 2270 with a separate TE-ID allocated for each such tunnel. The TE-IDs allocated for tunnels 2250, 2260, and 2270 are the same, but are distinguished as a result of the separate distinct IP addresses that are derived from a corresponding IP address of an AP (2210, 2220, or 2230) from which each path is established.

The GANC uses the TE-IDs to index a set of proxy IP addresses within the mapping table of FIG. 21. Based on the mapping table, tunnels 2250, 2260, and 2270 that share the same TE-ID are assigned the same proxy IP address while tunnel 2280 that is associated with a different TE-ID is assigned a different proxy IP address. As a result, the three actual IP addresses assigned to the APs 2210-2230 are reduced to only two destination IP addresses that are used in establishing paths between the GANC and the SGSN. Further reductions in the number of destination IP addresses result are achieved when more the TE-IDs are shared between the various APs serviced by the GANC. Moreover, such mapping functionality allows some embodiments to scale to support a virtually unlimited number of APs while only exposing the set of proxy IP addresses to the core network. As noted above, some embodiments cap the number of proxy IP addresses to reflect the maximum number of GTP paths supported by any single AP.

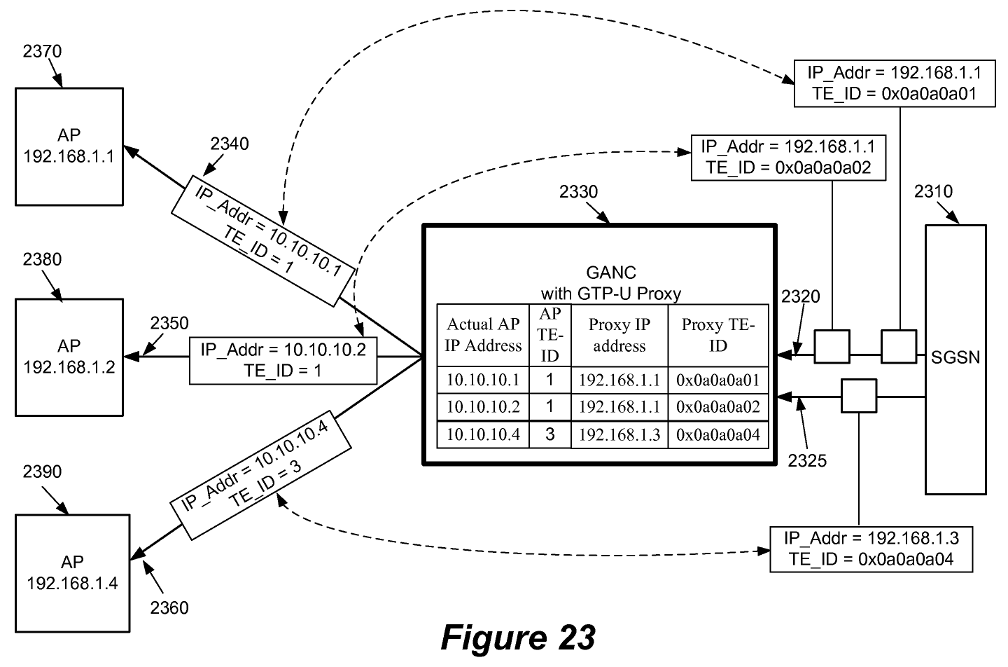

As noted above, the GANC or the path proxy management component of the GANC is responsible for remapping the reduced set of proxy addresses back to the actual IP addresses for downlink data transmission. FIG. 23 illustrates an implementation of the mapping functionality performed by some embodiments for downlink data transmission.

In this figure, the GANC 2330 performs a reverse lookup into the mapping table of FIG. 21 for downlink packets received from the core network over the tunnels 2320 and 2325. The lookup uses the proxy IP address of the downlink packet to index the TE-ID allocated for the data path allocated between the GANC 2330 and one of the APs 2370-2390. The correct receiving AP is identified based on the TE-ID of the downlink packet that contains the actual IP address of the receiving AP. Therefore to perform the mapping, the GANC replaces (1) the proxy IP address on the incoming packet with the TE-ID that stores the actual IP address of the receiving AP, (2) and the TE-ID of the downlink data packet is replaced with the actual TE-ID allocated for the path between the AP and the GANC by using the proxy IP address to index the mapping table to identify the allocated TE-ID.

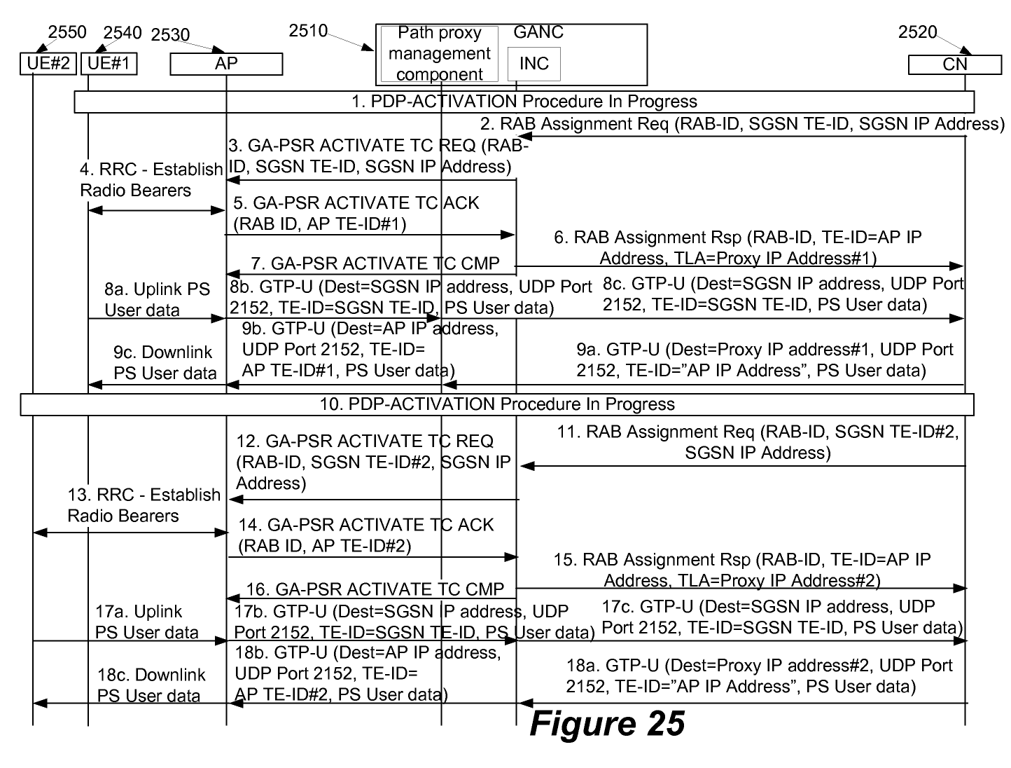

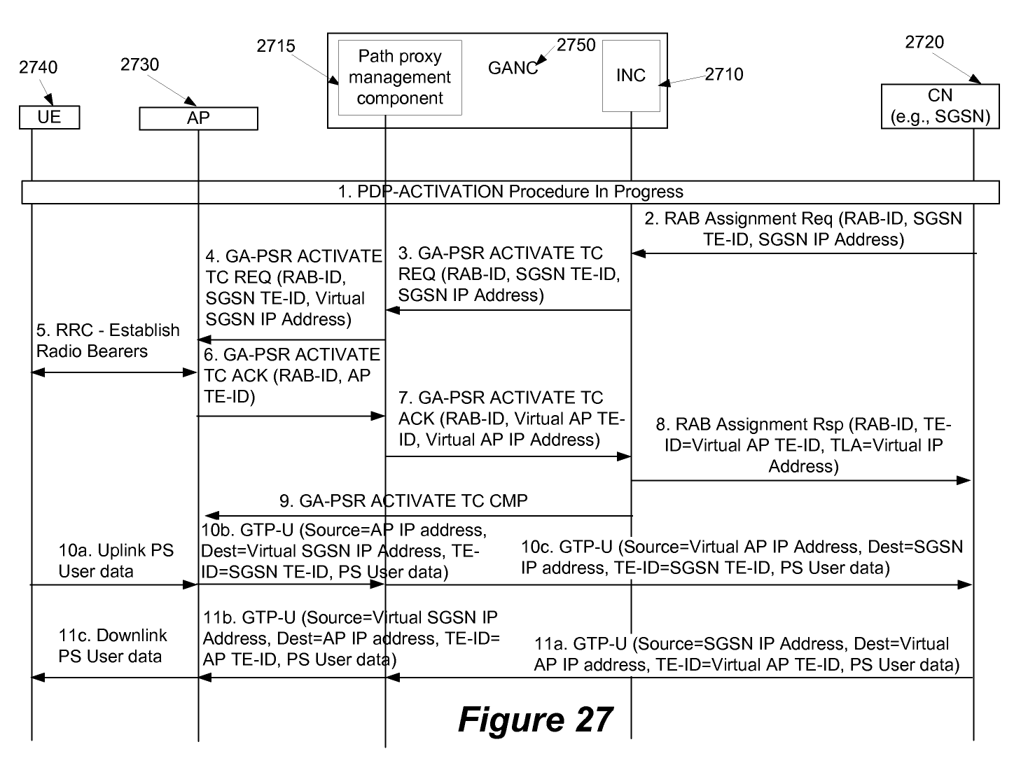

FIG. 24 presents a message and data flow diagram that illustrates some of the messages and operations employed to facilitate the fixed proxy mapping functionality in accordance with some embodiments of the invention. This figure and FIGS. 25 and 27 below are described in context of GA-PSR messaging, however it should be apparent to one of ordinary skill in the art that any ICS compatible protocol (e.g., RANAP) or interface (e.g., Iu-h, Up, etc.) may be used to perform the functionality described in these figures. For example, the GA-PSR ACTIVATE REQ message may be implemented by a RANAP direct transfer message. Transport of RANAP messages is described in the above incorporated U.S. Provisional Patent Application 61/058,912. Further details of the RANAP protocol can be found in 3GPP TS 25.413 “UTRAN Iu interface Radio Access Network Application Part (RANAP) signaling”. The 3GPP TS 25.413 is incorporated herein by reference.

The messages of FIG. 24 occur during or subsequent to a PDP Activation procedure for creating a GTP-U tunnel. As shown, the PDP Activation procedure and the mapping functionality commence when a GANC 2410 receives (at step 2) a Radio Access Bearer (RAB) Assignment Request from a data service providing component of a core network (i.e., the SGSN 2420). The RAB assignment request contains information about the uplink GTP-U tunnel such as the IP address and TE-ID of the SGSN 2420. In some embodiments, the RAB Assignment Request is encapsulated as a RANAP message.

The SGSN identification information is then conveyed from the GANC 2410 to the AP 2430. In some embodiments, the information is passed (at step 3) using a GA-PSR ACTIVATE TC message. In some other embodiments, the information is passed using a standard RANAP message that may be encapsulated via an adaption layer. It should be apparent to one of ordinary skill in the art that the transmitted message may also include other necessary information.

The AP 2430 and UE 2440 then establish (at step 4) radio bearers. Once complete, the AP 2430 sends an acknowledgement message to acknowledge the tunnel activation. In some embodiments, the acknowledgement message is passed (at step 5) using a GA-PSR TC Activate ACK message and in some other embodiments the acknowledgement message is passed using a standard RANAP message that may be encapsulated via an adaption layer. In this message, the AP 2430 includes its allocated TE-ID.

The TE-ID of the AP 2430 will fall within a preconfigured range of proxy IP addresses of the GANC 2410. The TE-ID is used to index and retrieve a proxy IP address in the range that is subsequently used in mapping (1) downlink packets from the smaller set of paths existing between the GANC 2410 and the core network to the larger set of paths existing between the GANC 2410 and the APs, and (2) uplink packets from the larger set of paths existing between the GANC 2410 and the APs to the smaller set of paths existing between the GANC 2410 and the core network.

As noted above with reference to FIGS. 21-23, some embodiments map the proxy IP address based on an index derived from the TE-ID assigned to the AP. In this manner, the maximum number of paths (i.e., destination IP addresses) used in data transfer between the GAN and the core network will not exceed the maximum number of tunnels supported by any given single AP. Moreover, for the downlink data transmission, the GANC will map the AP IP address in the TE-ID field of the downlink data packet to the destination IP address field and use the proxy IP address to identify the original TE-ID assigned to the AP.

The GANC 2410 then creates (at step 6) a RAB Assignment Response message to send to the SGSN 2420 with the paths between the AP 2430 and the GANC 2410 being mapped to a smaller set of paths. Specifically, the GANC 2410 assigns a proxy IP address to be used for the transfer of data between the GANC 2410 and the SGSN 2420. Accordingly, the RAB Assignment Response message includes the IP address of the AP 2430 as the TE-ID and the transport layer address field is populated with the proxy IP address. The GANC 2410 then responds to the AP 2430 with an Activate complete message which in some embodiments is passed (at step 7) as a GA-PSR ACTIVATE TC CMP message.

At this stage in the message flow, the path termination and path mapping functionality are setup such that subsequent uplink data transmissions are mapped (at step 8) in a manner that reduces the number of paths between the GANC 2410 and the core network as described above in FIGS. 21-22. Similarly, downlink data transmissions are mapped (at step 9) in a manner that receives the reduced number of paths between the GANC 2410 and core network 2420 and converts the paths back to the larger number of paths established between the GANC 2410 and the various APs as described above in FIG. 23.

FIG. 25 presents a message and data flow diagram that illustrates the setting up of multiple GTP-U tunnels from the same AP in accordance with some embodiments. As shown, steps 1-9 of FIG. 25 are identical to steps 1-9 of FIG. 24 for setting up a first GTP-U path between a particular AP 2530 and a GANC 2510 for packet switched services of a first UE 2540. Additionally, FIG. 25 further includes steps 10-18 for setting up a second GTP-U path between the particular AP 2530 and the GANC 2510 for packet switched services of a second UE 2550.

Specifically, a PDP-Activation procedure commences for the second UE 2550 when the GANC 2510 receives (at step 11) a Radio Access Bearer (RAB) Assignment Request from the data service providing component of a core network 2520. In this instance, the RAB assignment request contains information about the uplink GTP-U tunnel. However, a second TE-ID is provided by the core network 2520 for the data session with the second UE 2550.

The SGSN identification information for the GTP-U tunnel of the second UE 2550 is then conveyed (at step 12) from the GANC 2510 to the particular AP 2530. The particular AP 2530 and second UE 2550 then establish (at step 13) radio bearers. Once complete, the particular AP 2530 sends (at step 14) an acknowledgement message to the GANC 2510 to acknowledge the tunnel activation. In this message, the particular AP 2530 includes a second TE-ID allocated for the data session with the second UE 2550 that is different than the TE-ID allocated for the data session with the first UE 2540. In this manner, the AP 2530 provides different TE-IDs for each UE 2540 and UE 2550 in order to differentiate the data session between the two. As such, a first GTP-U tunnel using the first AP TE-ID is terminated between the AP 2530 and the GANC 2510 and a second GTP-U tunnel using the second AP TE-ID is terminated between the AP 2530 and the GANC 2510.

The GANC 2510 then creates (at step 15) a RAB Assignment Response message containing the mapped addressing to send to the SGSN 2520. The GANC 2510 responds (at step 16) to the AP 2530 with an Activate complete message.

For each subsequent uplink data transmission from either the first UE 2540 or the second UE 2550, the user data is mapped (at steps 8 and 17) from the larger set of GTP-U tunnels terminated between the particular AP 2530 and the GANC 2510 to the smaller set of GTP-U tunnels terminated between the GANC 2510 and the core network 2520. Specifically, the AP TE-IDs are mapped to unique proxy IP addresses such that a single tunnel using a single TE-ID (e.g., SGSN TE-ID) can be reused. Similarly, downlink data transmissions are mapped (at step 18) in a manner that receives PS user data over the reduced number of paths terminated between the GANC 2510 and the core network 2520 and maps the PS user data over the larger number of paths established between the GANC 2510 and the various APs. These mappings are described above with reference to FIGS. 21-23.

It should be apparent to one of ordinary skill in the art that even though FIGS. 21-25 and other subsequent figures illustrate the GTP-U path proxy management component as part of the GANC, in some embodiments, the GANC logically represents a collection of network controller components (SeGW, MGM, etc.). In some such embodiments, the GTP-U proxy may be located in a physically disparate location from the GANC without affecting the above described path mapping functionality.

C. Auto-Configuration (Application Level Gateway)

In some embodiments, the path terminating and path mapping functionality reduces all established GTP-U paths between a particular ICS network controller and several APs serviced by the network controller to a single virtual GTP-U path that is established between the network controller and a data service providing component (e.g., SGSN) of the core network. In some such embodiments, virtual TE-IDs and virtual IP addresses are automatically configured by the GTP-U path proxy management component to perform such a mapping.

In some embodiments, the GTP-U path proxy management component performs the automatic configuration of the virtual TE-IDs and virtual IP address by intercepting and modifying GTP-U Activate Transport Channel messages exchanged between APs and the INC of the network controller. Specifically, the GTP-U path proxy management component is configured with a single virtual AP IP address to be used by the SGSN (e.g., core network) as the destination IP address for downlink GTP-U packets. Additionally, the GTP-U path proxy management component also allocates a locally unique TE-ID for the downlink transfer of each GTP-U of an AP serviced by the ICS network controller. The locally unique TE-ID ensures that no two GTP-U tunnels share the same TE-ID for the downlink transfer.

The allocation of the virtual information for downlink transfer is as follows:
(1) Set the downlink TE-ID to the Virtual AP TE-ID which is the locally allocated unique TE-ID
(2) Set the downlink destination IP address to the Virtual AP IP address

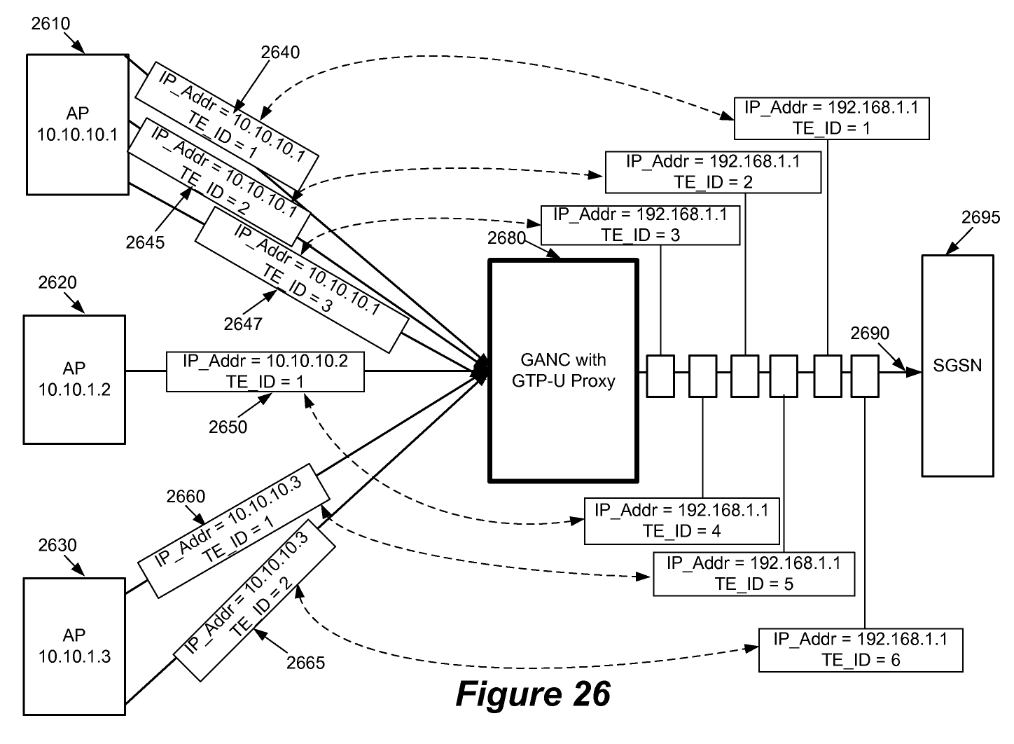

Accordingly, the GTP-U path proxy management component dynamically and intelligently allocates the virtual TE-IDs and overwrites each AP allocated TE-ID. FIG. 26 conceptually illustrates the automatic configuration functionality that facilitates the dynamic allocation and mapping of the larger set of set of GTP-U paths established between APs and a GANC and a single path established between the GANC and a SGSN.

As shown, three APs 2610-2630 each establish one or more GTP-U tunnels 2640-2670 with the GANC 2680. The GANC 2680 includes the path proxy management component. The path proxy management component performs the automatic configuration of the virtual addressing parameters to map all such tunnels 2640-2670 coming over multiple GTP-U paths to multiple GTP-U tunnel over a single path 2690 that is established between the GANC 2680 and the SGSN 2695 of the core network.

To do so, the GANC 2680, specifically the path proxy management component of the GANC 2680, intercepts both the uplink and downlink transmitted data and updates the addressing parameters as illustrated in FIG. 26. In some embodiments, the path proxy management component contains internal logic used to associate each AP IP address and TE-ID combination to a unique virtual AP TE-ID value and a single virtual AP IP address.

In some embodiments, automatic configuration of addressing parameters is performed based on different set of criteria. For example, the automatic configuration may proceed by allocating virtual TE-IDs based on a “first-come first-serve” approach. In this example, a first GTP-U path of an AP is allocated a first virtual TE-ID. The path proxy management component then increments the virtual TE-ID value to allocate the next established GTP-U path the incremented virtual TE-ID.

FIG. 27 presents a message and data flow diagram that illustrates some of the messages and operations employed to facilitate automatic configuration of virtual addressing and identifiers for path mapping in accordance with some embodiments of the invention. The following messages occur during or subsequent to a PDP Activation procedure for creating a GTP-U tunnel. As before, the PDP Activation procedure and the mapping functionality commence when an INC 2710 of a GANC 2750 receives (at step 2) a Radio Access Bearer (RAB) Assignment Request from a data service providing component of a core network (i.e., the SGSN 2720). The RAB assignment request contains information about the uplink GTP-U tunnel such as the IP address and TE-ID of the SGSN 2720. In some embodiments, the RAB Assignment Request is encapsulated as a RANAP message.

The SGSN identification information is then conveyed from the INC 2710 to the AP 2730. In some embodiments, the information is passed using a GA-PSR ACTIVATE TC message. In some other embodiments, the information is passed using a standard RANAP message that may be encapsulated via an adaption layer. However, the passed information is first intercepted (at step 3) by the GTP-U path proxy management component 2715 of the GANC 2750.

The GTP-U path proxy management component 2715 intercepts the ACTIVATE TC message in order to update the message with the appropriate virtual information. In some embodiments, the SGSN IP Address of the ACTIVATE TC message is replaced with a virtual SGSN IP address. In some embodiments, the mapping of the SGSN IP Address to the virtual SGSN IP address is optional. Specifically, some embodiments perform the mapping of the SGSN IP address to the virtual SGSN IP address in order to secure the actual SGSN IP address from being exposed to CPE (e.g., AP). Such masking is further described below in Subsection D. The GTP-U path proxy management component 2715 then relays (at step 4) the updated message to the AP 2730.

The AP 2730 and UE 2740 then establish (at step 5) radio bearers. Once complete, the AP 2730 sends an acknowledgement message to acknowledge the tunnel activation. In some embodiments, the acknowledgement message is passed (at step 6) using a GA-PSR TC Activate ACK message and in some other embodiments the acknowledgement message is passed using a standard RANAP message that may be encapsulated via an adaption layer. In this message, the AP 2730 includes an allocated TE-ID.

The GTP-U path proxy management component 2715 intercepts and updates this message that is sent from the AP 2730. The GTP-U path proxy management component 2715 replaces the AP TE-ID in the message with a virtual AP TE-ID and a virtual AP IP Address. As noted above, the allocated virtual AP TE-ID will be unique from all other virtual AP TE-ID allocated for any other GTP-U established between any AP and the GANC 2750. Conversely, the allocated virtual AP IP Address will be the same for all such APs.

The updated message is then relayed (at step 7) from the GTP-U path proxy management component 2715 to the INC 2710 of the GANC 2750. The INC 2710 extracts the virtual AP IP address and virtual AP TE-ID from the GA-PSR ACTIVATE TC message.

The INC 2710 then sends (at step 8) a corresponding RAB Assignment Response message to the SGSN 2720. The RAB Assignment Response message includes the virtual AP IP address that is shared for all GTP-U paths established between any AP serviced by the GANC 2750 and the GANC 2750. The INC 2710 then responds to the AP 2730 with an Activate complete message which in some embodiments is passed (at step 9) as a GA-PSR ACTIVATE TC CMP message.

It should be apparent to one of ordinary skill in the art that steps 1-8 above occur when a GTP-U does not already exist between the GANC 2750 and the SGSN 2720. When the path already exists, the GTP-U path proxy management component 2715 need only allocate a unique TE-ID for a new GTP-U path established between an AP and the GANC 2750. In this manner, each path established between the AP and the GANC 2750 can be uniquely identified and mapped during uplink or downlink transfer.

Steps 10 and 11 illustrate one such example of the identification and mapping that occurs using the automatically configured virtual information. At step 10, the UE 2740 initiates (at step 10a) uplink data transfer. The AP 2730 passes data received from the UE 2740 over a GTP-U path established between the AP 2730 and the GANC 2750. The message sent (at step 10b) from the AP 2730 includes the AP IP address as the source IP address and the virtual SGSN IP address as the destination IP address. Additionally, the message includes the SGSN TE-ID as the target TEID and other PS user data.

The GTP-U path proxy management component 2715 intercepts the passed message. The GTP-U path proxy management component 2715 updates the contents of the message by replacing the AP IP address with the virtual AP IP address and replacing the virtual SGSN IP address with the actual SGSN IP address. The updated message is then relayed (at step 10c) to the SGSN 2720.

Similarly, for downlink data transmission, the GTP-U path proxy management component 2715 intercepts the message passed (at step 11a) from the SGSN 2720. The GTP-U path proxy management component 2715 updates the contents of the message by (1) replacing the source SGSN IP address with the virtual SGSN IP address, (2) replacing the destination virtual AP IP address with the appropriate mapping to the actual AP IP address, and (3) replacing the virtual SGSN IP address with the appropriate mapping to the actual AP TE-IP. The updated message is then relayed (at step 11b) to the appropriate AP which then forwards (at step 11c) the downlink PS user data to the UE 2740.

D. IP Address Masking

Some embodiments employ security enhancement features when performing the path termination and path mapping functionality. Specifically, the GANC of some embodiments may optionally support IP address masking such that the real IP address of the SGSN is never exposed to the APs. Instead, the real SGSN IP address is replaced with a virtual SGSN IP address in both the uplink as well as the downlink GTP-U data packets. Accordingly, an additional set of proxy IP addresses are mapped to mask the SGSN IP address in the downlink data transmission and to unmask packets in the uplink data transmission. In some embodiments, IP address masking is performed via the use of one-to-one static Network Address Translation (NAT) function. In some embodiments, the following IP address masking may be used in conjunction with the above described tunnel mapping functionalities (e.g., fixed proxy and automatic configuration).

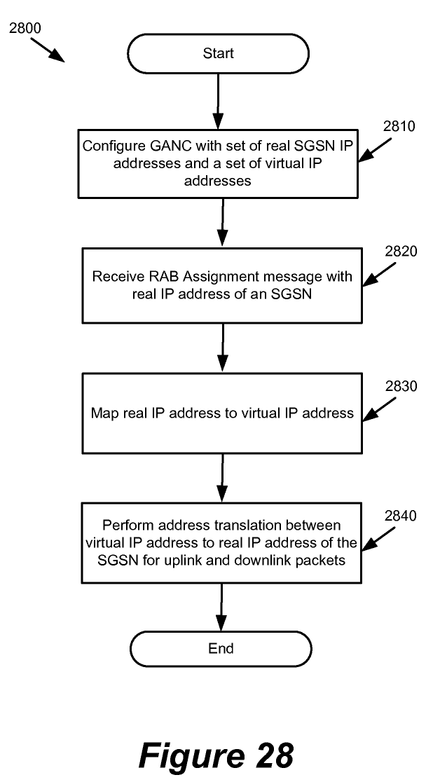

FIG. 28 presents a process 2800 implemented in conjunction with the path mapping functionality described above to provide IP address masking functionality for components of the core network (e.g., SGSN). The process 2800 begins by configuring (at 2810) the GANC with a set of real SGSN IP addresses. For each real SGSN IP address, there is a corresponding virtual SGSN IP address configured.

During the GTP tunnel setup, the GANC receives (at 2820) the RAB Assignment message which contains the real IP address of an SGSN through which data services are provided. The real IP address is mapped (at 2830) to the virtual IP address according to the configuration at step 2810. The virtual IP address is then relayed to the AP as the uplink GTP-U end point IP address. In some embodiments, this information is passed to the AP via an GA-PSR ACTIVATE TC REQ message.

Thereafter, the process performs (at 2840) the address translation for the uplink packets. For example, uplink GTP-U packets from the AP destined to the virtual SGSN IP address will be transformed to the real IP address of the SGSN. The process performs (at 2840) a similar translation for downlink packets. For example, downlink GTP-U packets from the SGSN with a source of real IP SGSN address will be transformed to use a source of a corresponding virtual SGSN IP address identified based on the configuration. It should be apparent to one of ordinary skill in the art that even though the process 2800 has been described in relation to a one-to-one static mapping that some embodiments also perform a dynamic mapping for the real SGSN IP address to virtual SGSN IP address.

### V. COMPUTER SYSTEM

Many of the above-described components (e.g., UE, FAP, HNB, GANC, HNB-G, etc.) implement some or all the above described functionality through software processes that are specified as a set of instructions recorded on a machine readable medium (also referred to as computer readable medium). When these instructions are executed by one or more computational element(s) (such as processors or other computational elements like ASICs and FPGAs), they cause the computational element(s) to perform the actions indicated in the instructions. Computer is meant in its broadest sense, and can include any electronic device with a processor. Examples of computer readable media include, but are not limited to, CD-ROMs, flash drives, RAM chips, hard drives, EPROMs, etc. Accordingly, the above described tunnel mapping functionalities (e.g., fixed proxy and automatic configuration) may be adapted to any computer equipment terminating/originating the GTP-U tunnels. Accordingly, such functionality is not limited to just the network controller of an ICS or a path proxy management component.

In this specification, the term “software” is meant in its broadest sense. It can include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention.

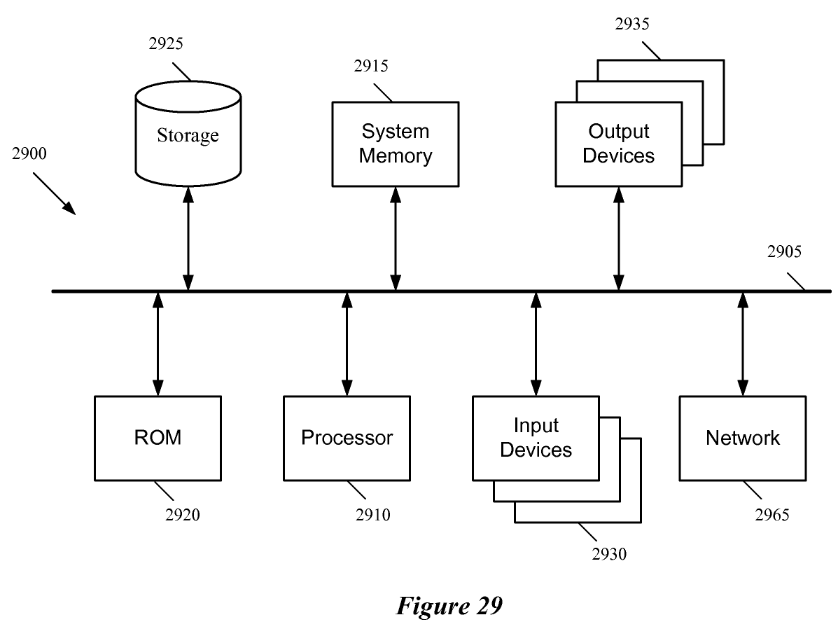

FIG. 29 illustrates a computer system with which some embodiments of the invention are implemented. Such a computer system includes various types of computer readable mediums and interfaces for various other types of computer readable mediums. Computer system 2900 includes a bus 2905, a processor 2910, a system memory 2915, a read-only memory 2920, a permanent storage device 2925, input devices 2930, and output devices 2935.

The bus 2905 collectively represents all system, peripheral, and chipset buses that communicatively connect the numerous internal devices of the computer system 2900. For instance, the bus 2905 communicatively connects the processor 2910 with the read-only memory 2920, the system memory 2915, and the permanent storage device 2925. From these various memory units, the processor 2910 retrieves instructions to execute and data to process in order to execute the processes of the invention.

The read-only-memory (ROM) 2920 stores static data and instructions that are needed by the processor 2910 and other modules of the computer system. The permanent storage device 2925, on the other hand, is a read-and-write memory device. This device is a non-volatile memory unit that stores instructions and data even when the computer system 2900 is off. Some embodiments of the invention use a mass-storage device (such as a magnetic or optical disk and its corresponding disk drive) as the permanent storage device 2925.

Other embodiments use a removable storage device (such as a floppy disk, flash drive, or ZIP® disk, and its corresponding disk drive) as the permanent storage device. Like the permanent storage device 2925, the system memory 2915 is a read-and-write memory device. However, unlike storage device 2925, the system memory is a volatile read-and-write memory, such a random access memory (RAM). The system memory stores some of the instructions and data that the processor needs at runtime. In some embodiments, the invention's processes are stored in the system memory 2915, the permanent storage device 2925, and/or the read-only memory 2920.

The bus 2905 also connects to the input and output devices 2930 and 2935. The input devices enable the user to communicate information and select commands to the computer system. The input devices 2930 include alphanumeric keyboards and pointing devices (also called “cursor control devices”). The input devices 2930 also include audio input devices (e.g., microphones, MIDI musical instruments, etc.). The output devices 2935 display images generated by the computer system. For instance, these devices display a GUI. The output devices include printers and display devices, such as cathode ray tubes (CRT) or liquid crystal displays (LCD).

Finally, as shown in FIG. 29, bus 2905 also couples computer 2900 to a network 2965 through a network adapter (not shown). In this manner, the computer can be a part of a network of computers (such as a local area network (“LAN”), a wide area network (“WAN”), or an Intranet, or a network of networks, such as the internet. For example, the computer 2900 may be coupled to a web server (network 2965) so that a web browser executing on the computer 2900 can interact with the web server as a user interacts with a GUI that operates in the web browser.

As mentioned above, the computer system 2900 may include one or more of a variety of different computer-readable media. Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ZIP® disks, read-only and recordable blu-ray discs, any other optical or magnetic media, and floppy disks.

It should be recognized by one of ordinary skill in the art that any or all of the components of computer system 2900 may be used in conjunction with the invention. For instance, some or all components of the computer system described with regards to FIG. 29 comprise some embodiments of the UE, AP, FAP, GANC, and other equipments of the UMA, GAN, and HNBAN networks described above. Moreover, one of ordinary skill in the art will appreciate that any other system configuration may also be used in conjunction with the invention or components of the invention. Thus, one of ordinary skill in the art would understand that the invention is not to be limited by the foregoing illustrative details, but rather is to be defined by the appended claims.

### VI. DEFINITIONS AND ABBREVIATIONS

The following is a list of definitions and abbreviations used:

| | |
|---|---|
| 3G | Third Generation |
| AAA | Authentication, Authorization and Accounting |
| AKA | Authentication and Key Agreement |
| AMR | Adaptive Multi-Rate |
| AMR-WB | Adaptive Multi-Rate Wideband |
| AP | Access Point |
| ASIC | Application Specific Integrated Circuit |
| ATM | Asynchronous Transfer Mode |
| BSC | Base Station |
| BSC | Base Station Controller |
| CBC | Cell Broadcast Center |
| CM | Connection Management |
| CN | Core Network |
| CPE | Customer Premise Equipment |
| CS | Circuit Switched |
| EAP | Extensible Authentication Protocol |
| EDGE | Enhanced Data for GSM Evolution |
| EPROM | Erasable Programmable Read Only Memory |
| FAP | Femtocell Access Point |
| FPGA | Field Programmable Gate Array |
| GA-CSR | Generic Access - Circuit Switched Resources |
| GA-PSR | Generic Access - Packet Switched Resources |
| GA-RC | Generic Access - Resource Control |
| GAN | Generic Access Network |
| GANC | Generic Access Network Controller |
| GERAN | GSM EDGE Radio Access Network |
| GGSN | Gateway GPRS Support Node |
| GMM/SM | GPRS Mobility Management and Session Management |
| GPRS | General Packet Radio Service |
| GSM | Global System for Mobile communications |
| GSN | GPRS Support Node |
| GTP | GPRS Tunneling Protocol |
| HLR | Home Location Register |
| HNB | Home Node B |
| HNB-G | Home Node B Gateway |
| HNBAN | Home Node B Access Network |
| HPLMN | Home PLMN |
| HSDPA | High Speed Downlink Packet Access |
| ICS | Integrated Communication System |
| IETF | Internet Engineering Task Force |
| IKE | Internet Key Exchange |
| IKEv2 | IKE Version 2 |
| IMEISV | International Mobile station Equipment Identity |
| | and Software Version number |
| IMSI | International Mobile Subscriber Identity |
| INC | IP Network Controller |
| IP | Internet Protocol |
| LLC | Logical Link Control |
| MAC | Medium Access Control |
| MGW | Media Gateway |
| MM | Mobility Management |
| MS | Mobile Station |
| MSC | Mobile Switching Center |
| MSS | MSC Server |
| NAS | Non-Access Stratum |
| NAT | Network Address Translation |
| PCS | Personal Communication Services |
| PDP | Packet Data Protocol |
| PDU | Protocol Data Unit |
| PLD | Programmable Logic Device |
| PLMN | Public Land Mobile Network |
| POTS | Plain Old Telephone Service |
| PS | Packet Switched |
| PSTN | Public Switched Telephone Network |
| RAB | Radio Access Bearer |
| RANAP | Radio Access Network Application Protocol |
| RAM | Random Access Memory |
| RLC | Radio Link Control |
| RNC | Radio Network Controller |
| RNS | Radio Network Subsystem |
| ROM | Read Only Memory |
| RRC | Radio Resource Control |
| RTF | Real Time Protocol |
| RUA | RANAP User Adaption |
| SAP | Service Access Interface |
| SEGW | Security Gateway |
| SGSN | Serving GPRS Support Node |
| SIM | Subscriber Identity Module |
| SIP | Session Initiation Protocol |
| SMLC | Serving Mobile Location Center |
| SMS | Short Message Service |
| SNDCP | Sub-Network Dependent Convergence Protocol |
| SRNS | Service Radio Network Subsystem |
| SSID | Service Set Identifier |
| STCP | Streams-Based TCP/IP |
| TC | Transport Channel |
| TCP | Transmission Control Protocol |
| TE-ID | Tunnel Endpoint Identifier |
| UE | User Equipment |
| UDP | User Datagram Protocol |
| UMA | Unlicensed Mobile Access |
| UMTS | Universal Mobile Telecommunication System |
| USB | Universal Serial Bus |
| UTRAN | UMTS terrestrial Radio Access Network |
| Up | Up is the Interface between UE and GANC |
| VLR | Visited Location Register |
| VoIP | Voice Over IP |
| VPLMN | Visited Public Land Mobile Network |

What is claimed is:

1. A method of minimizing a number of active data paths between a wireless communication network comprising at least one service region and a network controller for communicatively coupling said service region to a core network, the method comprising:
identifying at least one identifier associated with data packets received over a first set of data paths terminated at the service region;
mapping the first set of data paths to a smaller set of second data paths terminated between the network controller and a data service providing component of the core network based on the identifier; and
passing said data packets through the second set of data paths to the core network.

2. The method of claim 1, wherein identifying the identifier comprises identifying an IP address and a tunnel endpoint identifier (TE-ID) associated with a particular data path through which a particular data packet was received.

3. The method of claim 2, wherein the IP address is an IP address of an access point that services a service region of the communication network.

4. The method of claim 2, wherein the IP address is an IP address of a telecommunications device operating within a particular service region of the communication network.

5. The method of claim 2, wherein mapping the first set of data paths to the second set of data paths comprises identifying a proxy IP address to replace said IP address of the particular data packet prior to passing the particular data packet to the core network.

6. The method of claim 5, wherein identifying the proxy IP address is performed using the TE-ID associated with the particular data path.

7. The method of claim 5, wherein mapping the first set of data paths to the second set of data paths further comprises replacing the identified TE-ID with the identified IP address prior to passing the particular data packet to the core network.

8. The method of claim 1 further comprising identifying at least identifier associated with data packets received over the second set of data paths.

9. The method of claim 8 further comprising mapping the second set of data paths to the first set of data paths based on the identifier identified from the data packets received over the second set of data paths.

10. The method of claim 1, wherein the data service providing component of the core network is a Serving GPRS Support Node (SGSN) of the core network.

11. A method of minimizing a number of active data paths for communications between a core network and a wireless communication network comprising a network controller that communicatively couples a service region of the communication network to the core network, the method comprising:
identifying at least one identifier for routing a data packet through a data path of a first set of data paths;
modifying said identifier with a proxy identifier for routing said data packet through a data path of a smaller second set of data paths; and
passing the modified data packet through the data path of the second set of data paths.

12. The method of claim 11, wherein the at least one identifier comprises an IP address associated with an access point servicing a service region of the communication network and a tunnel endpoint identifier (TE-ID) associated with the data path of the first set of data paths.

13. The method of claim 12, wherein the modifying of the identifier with the proxy identifier comprises mapping a proxy IP address that is shared between data paths of the first set of paths that have the same TE-ID to the IP address of the data packet.

14. The method of claim 13, wherein the modifying of the identifier with the proxy identifier further comprises mapping a proxy TE-ID to the TE-ID associated with the data packet, wherein the proxy TE-ID is the IP address of the data packet.

15. The method of claim 11, wherein the first set of data paths are terminated between the network controller and at least one service region of the communication network.

16. The method of claim 15, wherein the second set of data paths are terminated between the network controller and a SGSN of the core network.

17. The method of claim 11, wherein the data paths comprise GTP tunnels.

18. A network controller of a wireless communication network for minimizing a number of active data paths for communications between a core network and the wireless communication network, the network controller comprising:
a first interface for terminating a first set of data paths through which data packets comprising at least one identifier are exchanged between the network controller and a plurality of service regions of the wireless communication network;
a second interface for terminating a smaller second set of data paths through which the data packets are exchanged between the network controller and the core network; and
a processor for mapping the first set of data paths to the smaller set of second data paths by modifying the identifier of the data packets with at least one proxy identifier for routing the modified data packets through a data path of the smaller second set of data paths.

19. The network controller of claim 18, wherein the wireless communication network is a Generic Access Network (GAN) and the network controller is a Generic Access Network Controller (GANC) of the wireless communication network.

20. The network controller of claim 18, wherein the wireless communication network is a Home Node B Access Network (HNBAN) and the network controller is a Home Node B Gateway.

21. The network controller of claim 18, wherein the second interface comprises a universal mobile telecommunication system (UMTS) terrestrial radio access network (UTRAN) Tu interface.

22. The network controller of claim 18, wherein the first interface terminates the first set of data paths with user equipment operating within service regions of the communication network.

23. The network controller of claim 18, wherein the first interface terminates the first set of data paths with access points servicing service regions of the communication network.

24. The network controller of claim 18, wherein the second interface terminates the second set of data paths with a Serving GPRS Support Node (SGSN) of the core network.

25. The network controller of claim 18, wherein the second interface terminates the second set of data paths with a Gateway GPRS Support Node (GGSN) of the core network.

26. A computer readable storage medium of a network controller that communicatively couples a service region of a wireless communication network to a core network, the computer readable medium storing a computer program for minimizing a number of active data paths for communications between the core network and the wireless communication network, the computer program comprising sets of instructions for:
identifying at least one identifier for routing a data packet through a data path of a first set of data paths;
modifying said identifier with a proxy identifier for routing said data packet through a data path of a smaller second set of data paths; and
passing the modified data packet through the data path of the second set of data paths.
